(19) United States
(12) Patent Application Publication
(10) Pub. No.: US 2017/0058594 A1
(43) Pub. Date: Mar. 2, 2017

(54) SAFETY GATE

(71) Applicant: Elbee Pty Ltd., Bondi Junction (AU)

(72) Inventor: Andrew Marsden, Hingham, MA (US)

(73) Assignee: Elbee Pty Ltd., Bondi Junction (AU)

(21) Appl. No.: 15/255,053

(22) Filed: Sep. 1, 2016

Related U.S. Application Data
(60) Provisional application No. 62/213,306, filed on Sep. 2, 2015.

(51) Int. Cl. E06B 3/36; E05D 7/04; E06B 11/04; E06B 9/00; E05D 7/00; E06B 11/02

(52) U.S. Cl. CPC E06B 3/36; E05D 7/0045; E06B 11/022; E06B 11/04; E06B 9/00; E05D 7/043; E05D 2007/0072; E06B 2009/002

(57) ABSTRACT

A safety gate for use in household openings, such as doorways, hallways, and stair landings. The gate includes a color-coded closed/opened status indicator. In some embodiments, the barrier may be unlocked and locked with one-handed operation. The gate may include an automatic closure mechanism for moving the door from the open position to the closed position.

### RELATED APPLICATIONS

This application claims priority under 35 U.S.C. §119(e) to U.S. Provisional Application Ser. No. 62/213,306, entitled “BOSTON GATE,” and filed on Sep. 2, 2015, which is herein incorporated by reference in its entirety.

### FIELD

Embodiments herein relate to a safety gates which include a highly visible, color-coded locked/unlocked status indicator for use in household openings, such as doorways, to provide a barrier for a toddler or a small child, or for any other suitable use.

### DISCUSSION OF THE RELATED ART

Safety gates are used throughout households to prevent babies, children, and pets from accessing unsafe areas, such as landings, stairs, or non-childproofed furniture or rooms. These gates, provide lightweight, movable, and secure barriers to prevent children from accessing or entering potentially dangerous areas.

One disadvantage of some safety gates is the requirement of two hands to open and close the gate. While this arrangement prevents unwanted openings from children, it also hinders adults who are often carrying children or household items in one of their hands.

Another disadvantage of some safety gates is the uncertainty of knowing from a distance whether the gate is locked. Adults and older children, will sometimes accidentally close, but not lock, a toddler safety gate. Without the locking mechanism engaged, a toddler or small child may open the gate and access unsafe areas.

### SUMMARY

Embodiments disclosed herein may address one or more of these disadvantages by providing a safety gate that may be easily opened and closed with one hand, and/or that has a color-coded status indicator that shows someone within visual range whether the gate is properly locked. Some embodiments disclosed herein provide a gate assembly with an improved automatic closure mechanism.

Additional features are described herein. In this respect, before explaining at least one embodiment in detail, it is to be understood that the invention is not limited in its application to the details of construction and to the arrangements of the components set forth in the following description or illustrated in the drawings. Other embodiments may be practiced in various manners.

According to some embodiments, a safety gate assembly includes a frame comprising a base frame member joining lower ends of two spaced apart lateral frame members, positioned in an opening through which selective entry is permitted; a barrier mountable on the frame via upper and lower hinge, wherein the barrier is pivotable relative to the frame between a closed position and an open position; wherein the frame can be reversibly positioned in the doorway to reverse the orientation of the open position of the barrier; a latch housing on the barrier on the opposing side of the upper hinge, the latch housing having a releasable latch mounted for movement relative to the barrier, the latch to engage the frame and the barrier simultaneously to retain the barrier in the closed position to establish a locked mode of the gate; an automatic closure mechanism adjacent to the lower hinge that automatically moves the barrier from the open position to the closed position, the automatic closure mechanism disposed on top of an upper surface of the base frame member, said automatic closure mechanism comprising a substantially flat recess disposed between two substantially vertical sidewalls with a plurality of protrusions extending outward, wherein at least part of a base of the barrier moves vertically up and down within the sidewalls and the protrusions when opened and closed, and rotates on top of the sidewalls and at least one of the protrusions during rotational movement; wherein the latch comprises at least one surface with a first color and a second color, further wherein the latch housing comprises at least one opening to allow a nearby observer to view only the first color when the gate assembly is locked, wherein the least one opening further allows the nearby observer to view only the second color when the gate assembly is unlocked.

According to one embodiment, a safety gate includes a frame comprising a base frame member joining lower ends of two spaced apart lateral frame members, positioned between two substantially flat lateral surfaces through which selective entry is permitted; a barrier mountable on the frame via upper and lower hinge, wherein the barrier is pivotable relative to the frame between a closed position and a forward open position and a rearward open position; wherein the frame can be reversibly positioned between two substantially flat surfaces, to reverse the orientation of the open position of the barrier; an automatic closure mechanism adjacent to the lower hinge that automatically moves the barrier from the rearward or forward open positions to the closed position, the automatic closure mechanism disposed on top of an upper surface of the base frame member, said automatic closure mechanism comprising a substantially flat recess disposed between two substantially vertical sidewalls with a plurality of protrusions extending outward, wherein at least part of a base of the barrier moves vertically up and down within the sidewalls and the protrusions when opened and closed, and rotates on top of the sidewalls and at least one of the protrusions during rotational movement; wherein the latch comprises two opposing surfaces, each surface having a first color and a second color, wherein the latch housing comprises an opening on either side of the gate assembly to allow a nearby observer to view only the first color when the gate assembly is locked and only the second color when the gate assembly is unlocked from either side of the gate assembly.

According to a further embodiment, a safety gate assembly includes a frame comprising a base frame member joining lower ends of two spaced apart lateral frame members, positioned between two substantially flat lateral surfaces through which selective entry is permitted; a barrier mountable on the frame via upper and lower hinge, wherein the barrier is pivotable relative to the frame between a closed position and a forward open position and a rearward open position; wherein the frame can be reversibly positioned between two substantially flat surfaces, to reverse the orientation of the open position of the barrier; a latch housing on the barrier on the opposing side of the upper hinge, the latch housing having a releasable latch mounted for movement relative to the barrier, the latch to engage the frame and the barrier simultaneously to retain the barrier in the closed position to establish a locked mode of the gate; an automatic closure mechanism adjacent to the lower hinge that automatically moves the barrier from the open position to the closed position, the automatic closure mechanism disposed on top of an upper surface of the base frame member, said automatic closure mechanism comprising a substantially flat recess disposed between two substantially vertical sidewalls with a plurality of protrusions extending outward, wherein at least part of a base of the barrier moves vertically up and down within the sidewalls and the protrusions when opened and closed, and rotates on top of the sidewalls and at least one of the protrusions during rotational movement; wherein the latch comprises at least one surface with a first color and a second color, further wherein the latch housing comprises at least one opening to allow a nearby observer to view only the first color when the gate assembly is locked, wherein the least one opening further allows the nearby observer to view only the second color when the gate assembly is unlocked.

Another embodiment of the subject invention is a safety gate assembly comprising: a frame comprising a base frame member joining lower ends of two spaced apart lateral frame members, positioned in an opening through which selective entry is permitted; a barrier mountable on the frame via upper and lower hinge, wherein the barrier is pivotable relative to the frame between a closed position and an open position; wherein the frame can be reversibly positioned in the doorway to reverse the orientation of the open position of the barrier; a latch housing on the barrier on the opposing side of the upper hinge, the latch housing having a releasable latch mounted for movement relative to the barrier, the latch to engage the frame and the barrier simultaneously to retain the barrier in the closed position to establish a locked mode of the gate; an automatic closure mechanism adjacent to the lower hinge that automatically moves the barrier from the rearward or forward open positions to the closed position, the automatic closure mechanism disposed on top of an upper surface of the base frame member, said automatic closure mechanism comprising a substantially flat recess disposed between two substantially vertical sidewalls with a plurality of protrusions extending outward, wherein at least part of a base of the barrier moves vertically up and down within the sidewalls and the protrusions when opened and closed, and rotates on top of the sidewalls and at least one of the protrusions during rotational movement; wherein the latch comprises two opposing surfaces, each surface having a first color and a second color, wherein the latch housing comprises an opening on either side of the gate assembly to allow a nearby observer to view only the first color when the gate assembly is locked and only the second color when the gate assembly is unlocked from either side of the gate assembly.

An additional embodiment is a safety gate assembly comprising: a frame comprising a base frame member joining lower ends of two spaced apart lateral frame members, positioned in a doorway through which selective entry is permitted; a barrier mountable on the frame via upper and lower hinge, wherein the barrier is pivotable relative to the frame between a closed position and an open position; wherein the frame can be reversibly positioned in the doorway to reverse the orientation of the open position of the barrier; a latch housing on the barrier on the opposing side of the upper hinge, the latch housing having a releasable latch mounted for movement relative to the barrier, the latch to engage the frame and the barrier simultaneously to retain the barrier in the closed position to establish a locked mode of the gate; an automatic closure mechanism adjacent to the lower hinge that automatically moves the barrier from the open position to the closed position, the automatic closure mechanism disposed on top of an upper surface of the base frame member, said automatic closure mechanism comprising a substantially flat recess disposed between two substantially vertical sidewalls with a plurality of protrusions extending outward, wherein at least part of a base of the barrier moves vertically up and down within the sidewalls and the protrusions when opened and closed, and rotates on top of the sidewalls and at least one of the protrusions during rotational movement; wherein the latch comprises at least one surface with a first color and a second color, further wherein the latch housing comprises at least one opening to allow a nearby observer to view only the first color when the gate assembly is locked, wherein the least one opening further allows the nearby observer to view only the second color when the gate assembly is unlocked.

Another embodiment of a safety gate assembly includes a frame comprising a base frame member joining lower ends of two spaced apart lateral frame members, positioned in a stairwell entrance through which selective entry is permitted; a barrier mountable on the frame via upper and lower hinge, wherein the barrier is pivotable relative to the frame between a closed position and a forward open position and a rearward open position; wherein the frame can be reversibly positioned between two substantially flat surfaces, to reverse the orientation of the open position of the barrier; a latch housing on the barrier on the opposing side of the upper hinge, the latch housing having a releasable latch mounted for movement relative to the barrier, the latch to engage the frame and the barrier simultaneously to retain the barrier in the closed position to establish a locked mode of the gate; an automatic closure mechanism adjacent to the lower hinge that automatically moves the barrier from the rearward or forward open positions to the closed position, the automatic closure mechanism disposed on top of an upper surface of the base frame member, said automatic closure mechanism comprising a substantially flat recess disposed between two substantially vertical sidewalls with a plurality of protrusions extending outward, wherein at least part of a base of the barrier moves vertically up and down within the sidewalls and the protrusions when opened and closed, and rotates on top of the sidewalls and at least one of the protrusions during rotational movement; wherein the latch comprises two opposing surfaces, each surface having a first color and a second color, wherein the latch housing comprises an opening on either side of the gate assembly to allow a nearby observer to view only the first color when the gate assembly is locked and only the second color when the gate assembly is unlocked from either side of the gate assembly.

Another embodiment of a safety gate assembly includes a frame comprising a base frame member joining lower ends of two spaced apart lateral frame members, positioned in an opening through which selective entry is permitted; a barrier mountable on the frame via upper and lower hinge, wherein the barrier is pivotable relative to the frame between a closed position and an open position; wherein the frame can be reversibly positioned in the doorway to reverse the orientation of the open position of the barrier; a latch housing on the barrier on the opposing side of the upper hinge, the latch housing having a releasable latch mounted for movement relative to the barrier, the latch to engage the frame and the barrier simultaneously to retain the barrier in the closed position to establish a locked mode of the gate; an automatic closure mechanism adjacent to the lower hinge that automatically moves the barrier from the open position to the closed position, the automatic closure mechanism disposed on top of an upper surface of the base frame member, said automatic closure mechanism comprising a substantially flat recess disposed between two substantially vertical sidewalls with a plurality of protrusions extending outward, wherein at least part of a base of the barrier moves vertically up and down within the sidewalls and the protrusions when opened and closed, and rotates on top of the sidewalls and at least one of the protrusions during rotational movement; wherein the latch housing comprises an opening on either side of the gate assembly to allow a nearby observer to view only a first color when the gate assembly is locked and only a second color when the gate assembly is unlocked from either side of the gate assembly.

A further embodiment of a safety gate assembly includes a frame comprising a base frame member joining lower ends of two spaced apart lateral frame members, positioned in an opening through which selective entry is permitted; a barrier mountable on the frame via upper and lower hinge, wherein the barrier is pivotable relative to the frame between a closed position and an open position; wherein the frame can be reversibly positioned in the doorway to reverse the orientation of the open position of the barrier; a latch housing on the barrier on the opposing side of the upper hinge, the latch housing having a releasable latch mounted for movement relative to the barrier, the latch to engage the frame and the barrier simultaneously to retain the barrier in the closed position to establish a locked mode of the gate; an automatic closure mechanism adjacent to the lower hinge that automatically moves the barrier from the open position to the closed position, the automatic closure mechanism disposed on top of an upper surface of the base frame member, said automatic closure mechanism comprising a substantially flat recess disposed between two substantially vertical sidewalls with a plurality of protrusions extending outward, wherein at least part of a base of the barrier moves vertically up and down within the sidewalls and the protrusions when opened and closed, and rotates on top of the sidewalls and at least one of the protrusions during rotational movement; wherein the latch comprises at least one sidewall with a first color and a second color, further wherein the latch housing comprises at least one opening to allow a nearby observer to view only the first color when the latch is engaged with the frame and the gate assembly is in the locked mode, wherein the least one opening further allows the nearby observer to view only the second color when the latch is disengaged from the frame and the gate assembly is in the unlocked mode.

Another embodiment of a safety gate assembly includes a frame comprising a base frame member joining lower ends of two spaced apart lateral frame members, positioned between two substantially flat lateral surfaces through which selective entry is permitted; a barrier mountable on the frame via upper and lower hinges, wherein the barrier is pivotable relative to the frame between a closed position and a forward open position and a rearward open position; wherein the frame can be reversibly positioned between two substantially flat surfaces, to reverse the orientation of the open position of the barrier; a latch housing on the barrier on the opposing side of the upper hinge, the latch housing having a releasable latch mounted for movement relative to the barrier, the latch to engage the frame and the barrier simultaneously to retain the barrier in the closed position to establish a locked mode of the gate; an automatic closure mechanism adjacent to the lower hinge that automatically moves the barrier from the open position to the closed position, the automatic closure mechanism disposed on top of an upper surface of the base frame member, said automatic closure mechanism comprising a substantially flat recess disposed between two substantially vertical sidewalls with a plurality of protrusions extending outward, wherein at least part of a base of the barrier moves vertically up and down within the sidewalls and the protrusions when opened and closed, and rotates on top of the sidewalls and at least one of the protrusions during rotational movement; wherein the latch housing comprises an opening on either side of the gate assembly to allow a nearby observer to view only a first color when the gate assembly is locked and only a second color when the gate assembly is unlocked from either side of the gate assembly.

An additional embodiment of a safety gate assembly includes a frame comprising a base frame member joining lower ends of two spaced apart lateral frame members, positioned between two substantially flat lateral surfaces through which selective entry is permitted; a barrier mountable on the frame via upper and lower hinge, wherein the barrier is pivotable relative to the frame between a closed position and a forward open position and a rearward open position; wherein the frame can be reversibly positioned between two substantially flat surfaces, to reverse the orientation of the open position of the barrier; a latch housing on the barrier on the opposing side of the upper hinge, the latch housing having a releasable latch mounted for movement relative to the barrier, the latch to engage the frame and the barrier simultaneously to retain the barrier in the closed position to establish a locked mode of the gate; an automatic closure mechanism adjacent to the lower hinge that automatically moves the barrier from the open position to the closed position, the automatic closure mechanism disposed on top of an upper surface of the base frame member, said automatic closure mechanism comprising a substantially flat recess disposed between two substantially vertical sidewalls with a plurality of protrusions extending outward, wherein at least part of a base of the barrier moves vertically up and down within the sidewalls and the protrusions when opened and closed, and rotates on top of the sidewalls and at least one of the protrusions during rotational movement; wherein the latch comprises at least one sidewall with a first color and a second color, further wherein the latch housing comprises at least one opening to allow a nearby observer to view only the first color when the latch is engaged with the frame and the gate assembly is in the locked mode, wherein the least one opening further allows the nearby observer to view only the second color when the latch is disengaged from the frame and the gate assembly is in the unlocked mode.

Another embodiment of a safety gate assembly includes a frame adapted to mount with a door frame bordering a doorway and a gate mounted on the frame for pivotable movement about a pivot axis between a closed position closing a walkway passage formed in the frame to block movement of a person through the walkway passage and an opened position opening the walkway passage to allow movement of a person through the walkway passage, wherein the frame can be reversibly positioned in the doorway to reverse the orientation of the open position of the gate; a releasable latch mounted for movement relative to the gate, the latch to engage the frame and the gate simultaneously to retain the gate in the closed position to establish a locked mode; an automatic closure mechanism adjacent to a lower hinge on the gate that automatically moves the gate from the open position to the closed position, the automatic closure mechanism disposed on top of an upper surface of a base frame member, said automatic closure mechanism comprising a substantially flat recess disposed between two substantially vertical sidewalls with a plurality of protrusions extending outward, wherein at least part of a base of the gate moves vertically up and down within the sidewalls and the protrusions when opened and closed, and rotates on top of the sidewalls and at least one of the protrusions during pivotable movement; wherein the latch comprises at least one surface with a first color and a second color, further wherein the latch housing comprises at least one opening to allow a nearby observer to view only the first color when the gate assembly is locked, wherein the least one opening further allows the nearby observer to view only the second color when the gate assembly is unlocked.

Another embodiment of a safety gate assembly includes a frame adapted to mount with a door frame bordering a doorway and a gate mounted on the frame for pivotable movement about a pivot axis between a closed position closing a walkway passage formed in the frame to block movement of a person through the walkway passage and an opened position opening the walkway passage to allow movement of a person through the walkway passage, wherein the frame can be reversibly positioned in the doorway to reverse the orientation of the open position of the gate; a releasable latch mounted for movement relative to the gate, the latch to engage the frame and the gate simultaneously to retain the gate in the closed position to establish a locked mode; an automatic closure mechanism adjacent to a lower hinge on the gate that automatically moves the gate from the open position to the closed position, the automatic closure mechanism disposed on top of an upper surface of a base frame member, said automatic closure mechanism comprising a substantially flat recess disposed between two substantially vertical sidewalls with a plurality of protrusions extending outward, wherein at least part of a base of the gate moves vertically up and down within the sidewalls and the protrusions when opened and closed, and rotates on top of the sidewalls and at least one of the protrusions during pivotable movement; wherein the latch comprises two opposing surfaces, each surface having a first color and a second color, wherein the latch housing comprises an opening on either side of the gate assembly to allow a nearby observer to view only the first color when the gate assembly is locked and only the second color when the gate assembly is unlocked from either side of the gate assembly.

A further embodiment of a safety gate assembly includes a frame adapted to mount with a door frame bordering a doorway and a gate mounted on the frame for pivotable movement about a pivot axis between a closed position closing a walkway passage formed in the frame to block movement of a person through the walkway passage and either forward or rearward opened positions opening the walkway passage to allow movement of a person through the walkway passage, wherein the frame can be reversibly positioned in the doorway to reverse the orientation of the forward and rearward open positions of the gate; a releasable latch mounted for movement relative to the gate, the latch to engage the frame and the gate simultaneously to retain the gate in the closed position to establish a locked mode ; an automatic closure mechanism adjacent to a lower hinge on the gate that automatically moves the gate from the rearward or forward open positions to the closed position, the automatic closure mechanism disposed on top of an upper surface of a base frame member, said automatic closure mechanism comprising a substantially flat recess disposed between two substantially vertical sidewalls with a plurality of protrusions extending outward, wherein at least part of a base of the gate moves vertically up and down within the sidewalls and the protrusions when opened and closed, and rotates on top of the sidewalls and at least one of the protrusions during pivotable movement; wherein the latch comprises at least one surface with a first color and a second color, further wherein the latch housing comprises at least one opening to allow a nearby observer to view only the first color when the gate assembly is locked, wherein the least one opening further allows the nearby observer to view only the second color when the gate assembly is unlocked.

Another embodiment of a safety gate assembly includes a frame adapted to mount with a door frame bordering a doorway and a gate mounted on the frame for pivotable movement about a pivot axis between a closed position closing a walkway passage formed in the frame to block movement of a person through the walkway passage and either forward or rearward opened positions opening the walkway passage to allow movement of a person through the walkway passage, wherein the frame can be reversibly positioned in the doorway to reverse the orientation of the forward and rearward open positions of the gate; a releasable latch mounted for movement relative to the gate, the latch to engage the frame and the gate simultaneously to retain the gate in the closed position to establish a locked mode; an automatic closure mechanism adjacent to a lower hinge on the gate that automatically moves the gate from the rearward or forward open positions to the closed position, the automatic closure mechanism disposed on top of an upper surface of a base frame member, said automatic closure mechanism comprising a substantially flat recess disposed between two substantially vertical sidewalls with a plurality of protrusions extending outward, wherein at least part of a base of the gate moves vertically up and down within the sidewalls and the protrusions when opened and closed, and rotates on top of the sidewalls and at least one of the protrusions during pivotable movement; wherein the latch comprises two opposing surfaces, each surface having a first color and a second color, wherein the latch housing comprises an opening on either side of the gate assembly to allow a nearby observer to view only the first color when the gate assembly is locked and only the second color when the gate assembly is unlocked from either side of the gate assembly.

An additional embodiment of a safety gate assembly includes a frame adapted to mount with a stairwell entrance border and a door mounted on the frame for pivotable movement about a pivot axis between a closed position closing a walkway passage formed in the frame to block movement of a person through the walkway passage and an opened position opening the walkway passage to allow movement of a person through the walkway passage, wherein the frame can be reversibly positioned in the stairwell entrance to reverse the orientation of the open position of the gate; a releasable latch mounted for movement relative to the door, the latch to engage the frame and the door simultaneously to retain the door in the closed position to establish a locked mode; an automatic closure mechanism adjacent to a lower hinge on the door that automatically moves the door from the open position to the closed position, the automatic closure mechanism disposed on top of an upper surface of a base frame member, said automatic closure mechanism comprising a substantially flat recess disposed between two substantially vertical sidewalls with a plurality of protrusions extending outward, wherein at least part of a base of the gate moves vertically up and down within the sidewalls and the protrusions when opened and closed, and rotates on top of the sidewalls and at least one of the protrusions during pivotable movement; wherein the latch comprises at least one surface with a first color and a second color, further wherein the latch housing comprises at least one opening to allow a nearby observer to view only the first color when the gate assembly is locked, wherein the least one opening further allows the nearby observer to view only the second color when the gate assembly is unlocked.

Another embodiment of a safety gate assembly includes a frame adapted to mount with a stairwell entrance border and a door mounted on the frame for pivotable movement about a pivot axis between a closed position closing a walkway passage formed in the frame to block movement of a person through the walkway passage and an opened position opening the walkway passage to allow movement of a person through the walkway passage, wherein the frame can be reversibly positioned in the stairwell entrance to reverse the orientation of the open position of the gate; a releasable latch mounted for movement relative to the door, the latch to engage the frame and the door simultaneously to retain the door in the closed position to establish a locked mode; an automatic closure mechanism adjacent to a lower hinge on the door that automatically moves the door from the open position to the closed position, the automatic closure mechanism disposed on top of an upper surface of a base frame member, said automatic closure mechanism comprising a substantially flat recess disposed between two substantially vertical sidewalls with a plurality of protrusions extending outward, wherein at least part of a base of the gate moves vertically up and down within the sidewalls and the protrusions when opened and closed, and rotates on top of the sidewalls and at least one of the protrusions during pivotable movement; wherein the latch comprises two opposing surfaces, each surface having a first color and a second color, wherein the latch housing comprises an opening on either side of the gate assembly to allow a nearby observer to view only the first color when the gate assembly is locked and only the second color when the gate assembly is unlocked from either side of the gate assembly.

In some embodiments, the door barrier or gate may move forward relative to the frame to an angle substantially 90 to 120 degrees.

In some embodiments, the automatic closure mechanism is composed of compressible resilient material.

In some embodiments, the first color is green and the second color is red.

In some embodiments, the lower hinge includes a hinge pin, rotatably mountable in a first channel disposed in the automatic gate stop, and a substantially aligned second channel in the base member frame.

In some embodiments, the latch housing engages and releases the latch with an external user-actuated button attached to an internal lever that engages the latch.

In some embodiments, the frame comprises pressure mounts on either side of the base member and on the exterior of both lateral frame members.

For purposes herein, the term “substantially” is defined as at least close to (and can include) a given value or state, as understood by a person of ordinary skill in the art.

### BRIEF DESCRIPTION OF DRAWINGS

Advantages will be apparent from the following detailed description of embodiments of an improved safety gate, which description should be considered in conjunction with the accompanying drawings, in which:

FIG. 1 is a front view of a safety gate;

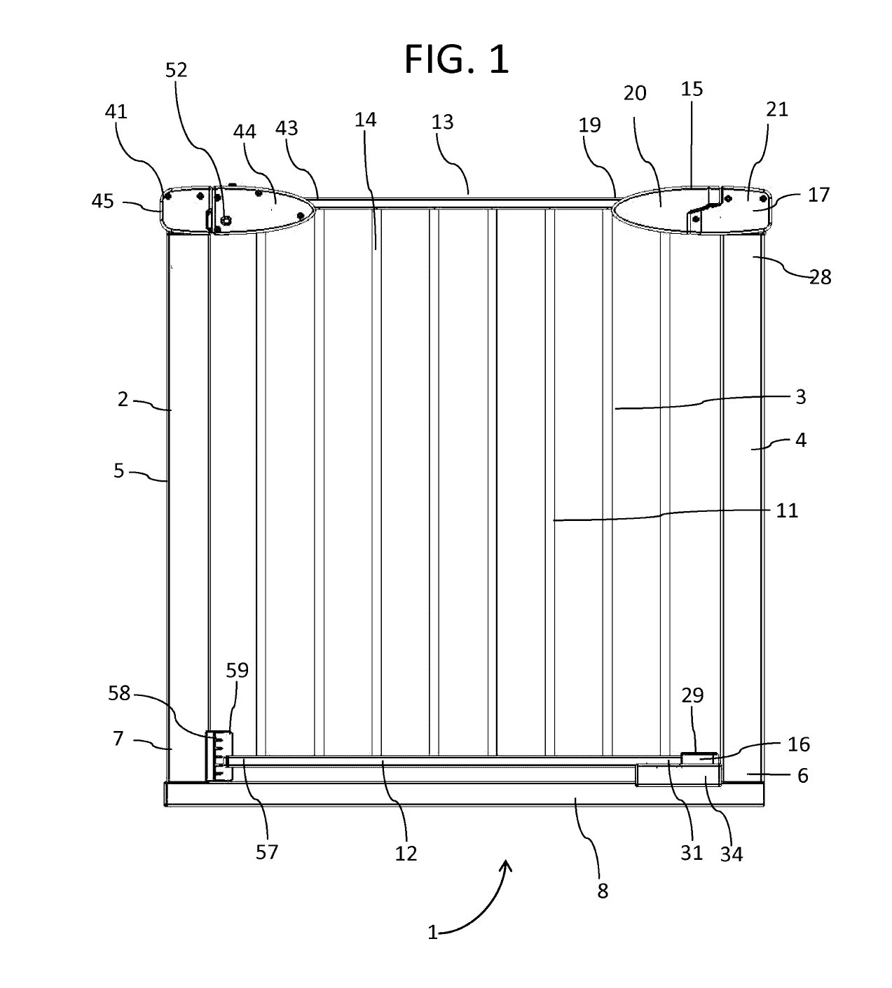

FIG. 2 is an exploded front view of a safety gate according to one embodiment;

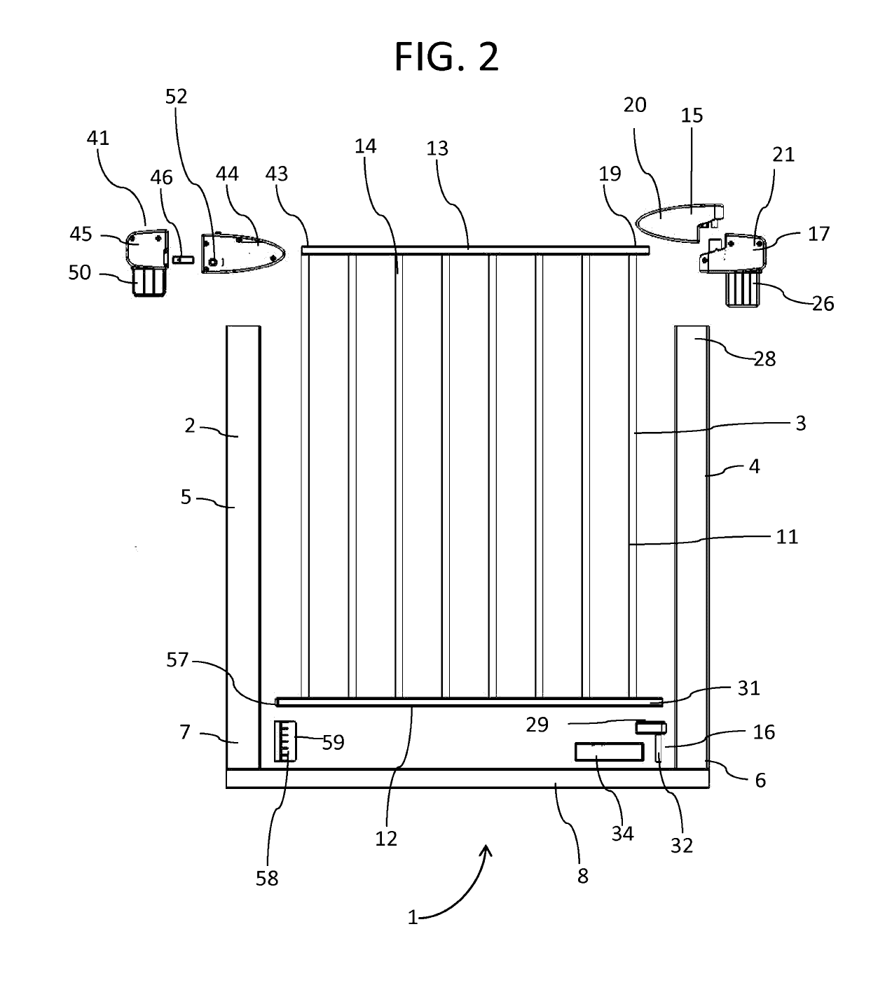

FIG. 3 is an isometric view of a safety gate according to one embodiment;

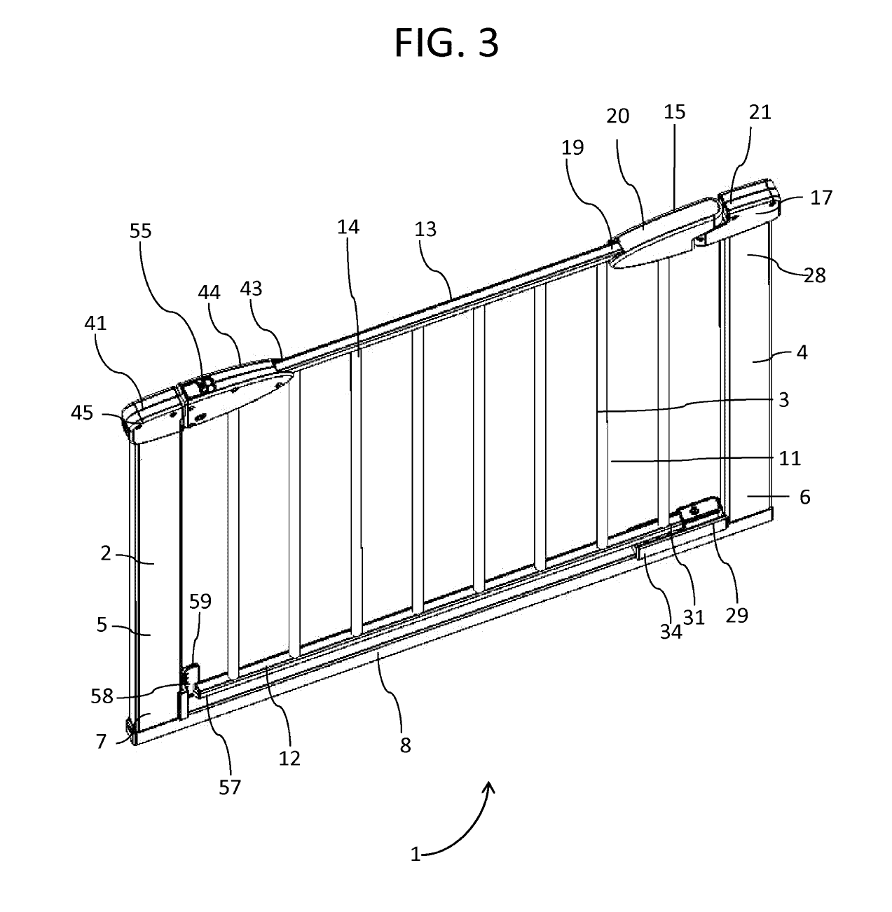

FIG. 4 is an exploded isometric view of a safety gate according to one embodiment;

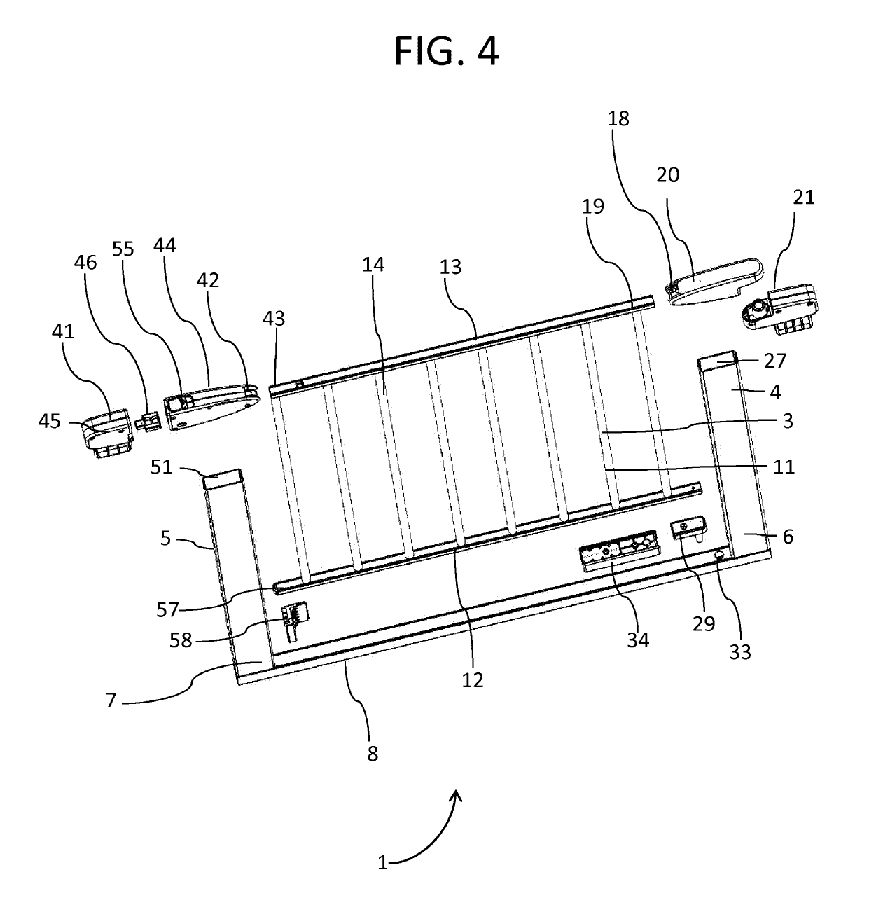

FIG. 5 is a front view of a safety gate with the door barrier in a rear open position;

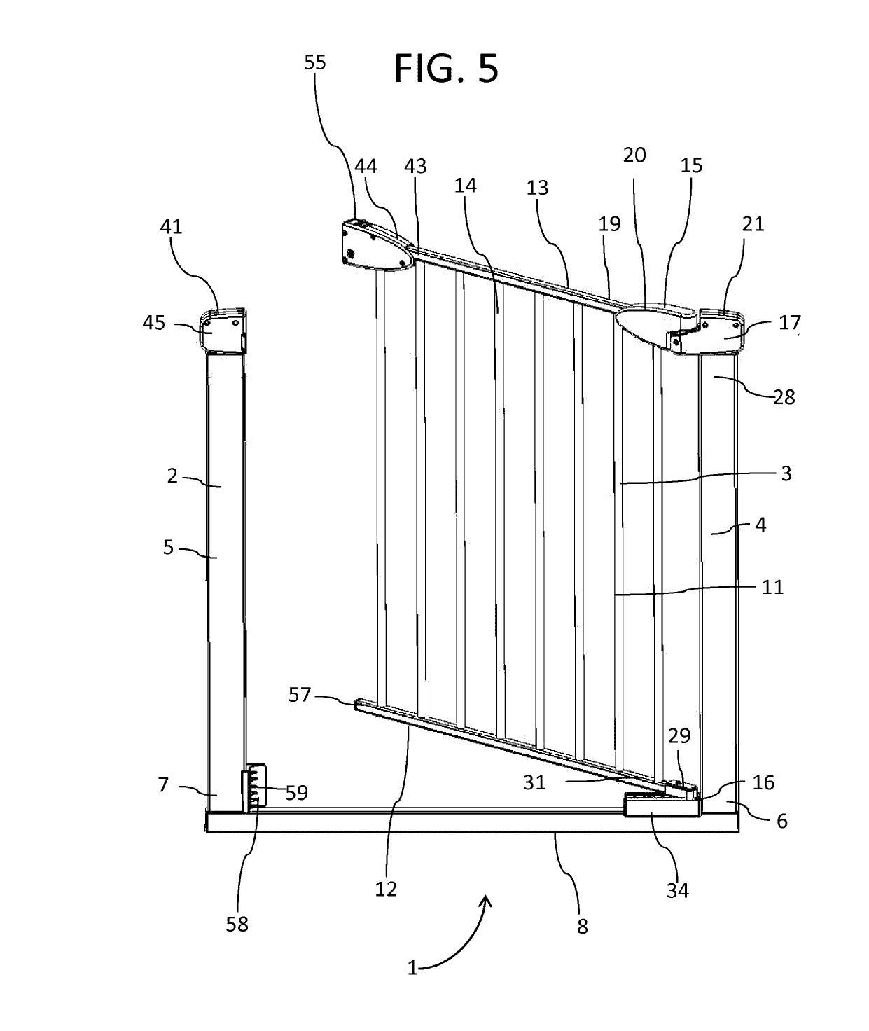

FIG. 6 is a front view of a safety gate with the door barrier in a forward open position;

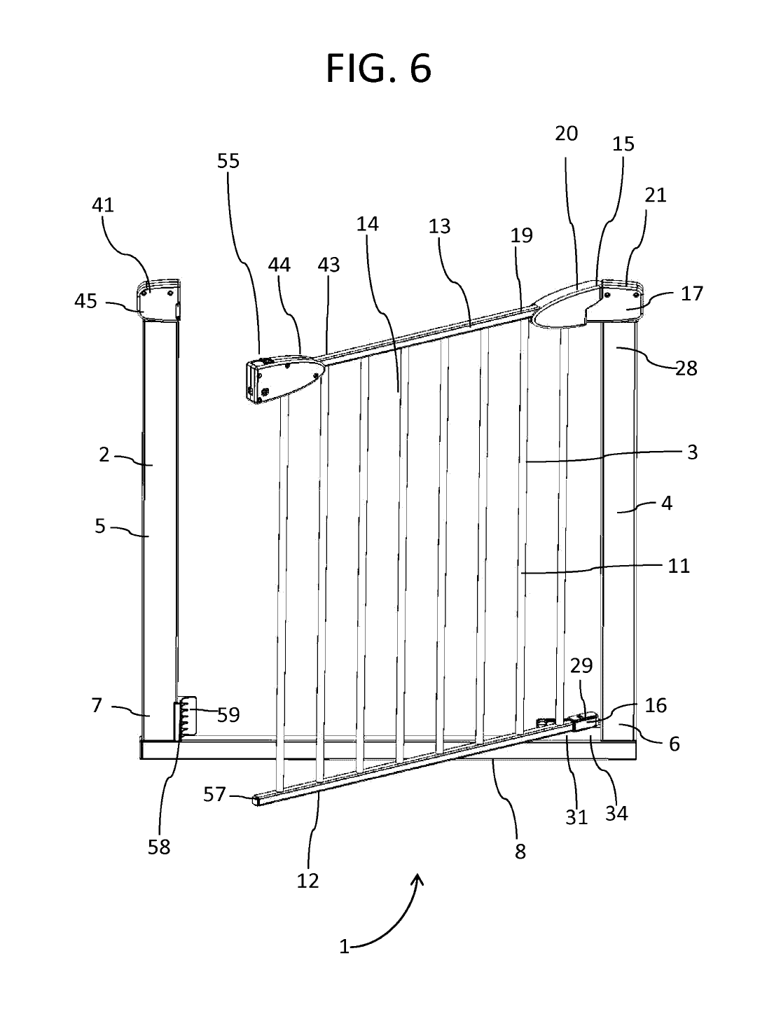

FIG. 7 is an isometric view of a safety gate with pressure mounts on a doorway;

FIG. 8 is a rear view of a safety gate;

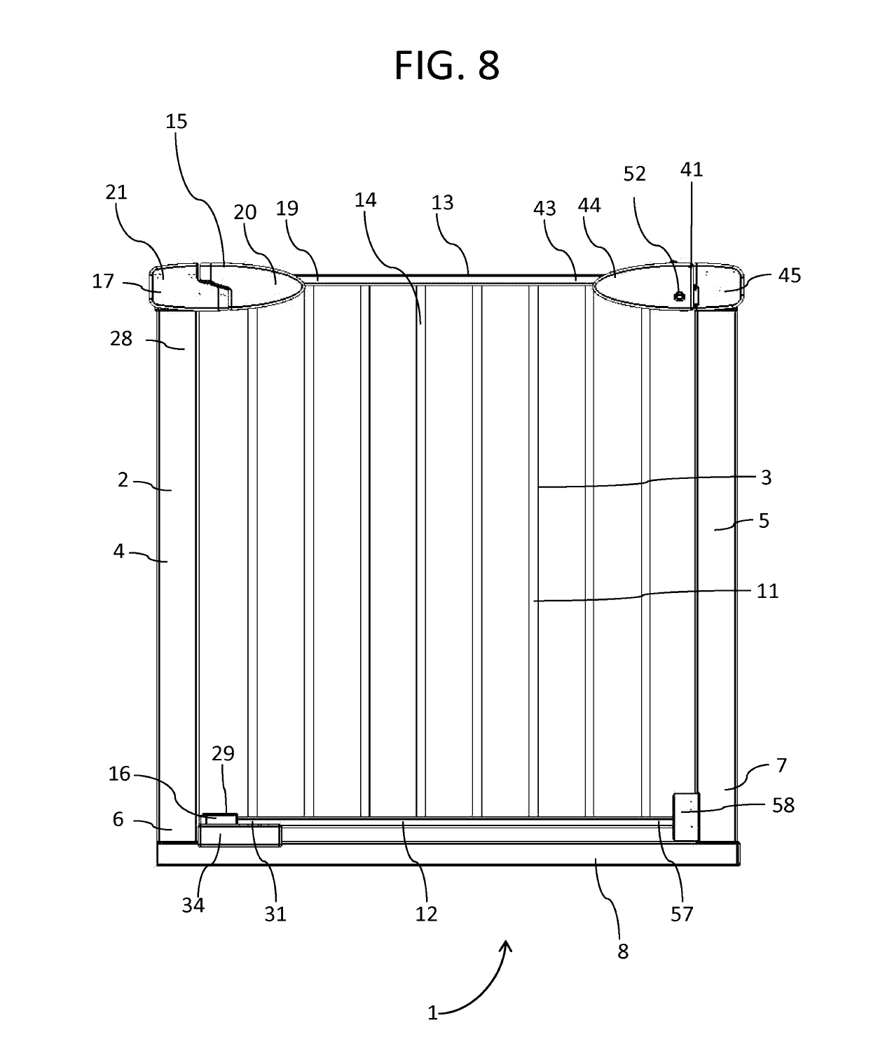

FIG. 9 is a rear view of a safety gate with pressure mounts on a doorway;

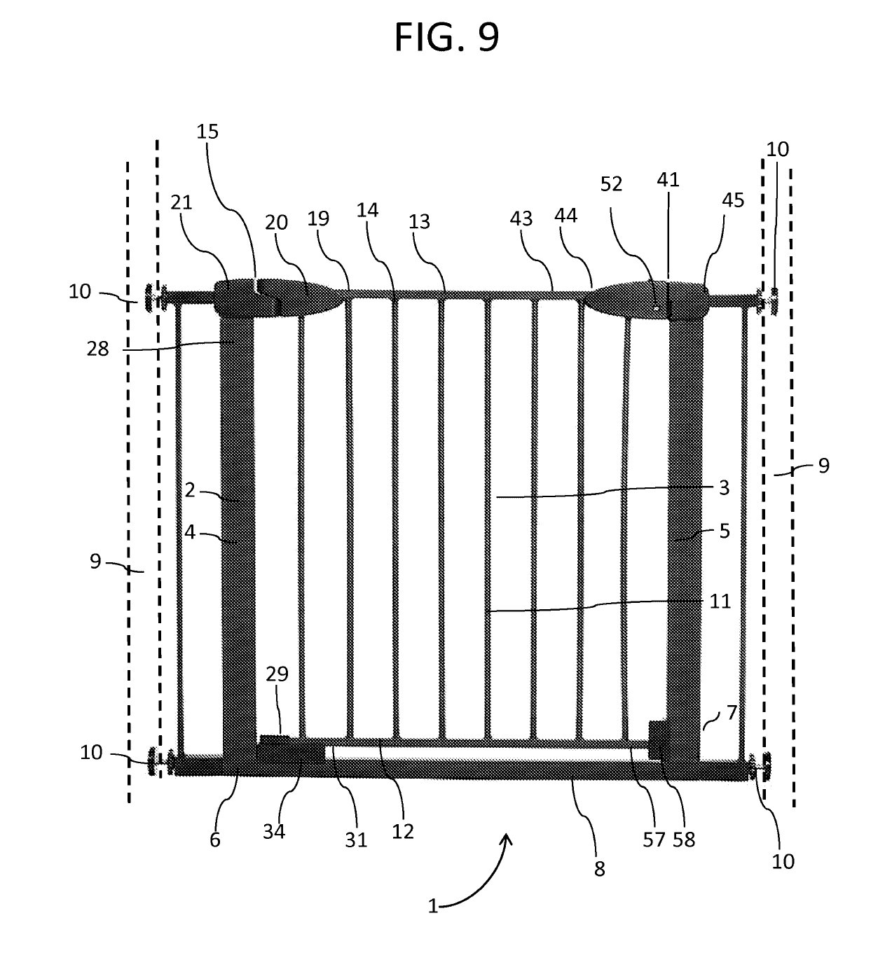

FIG. 10 is an enlarged side view of the hinge housing of a safety gate;

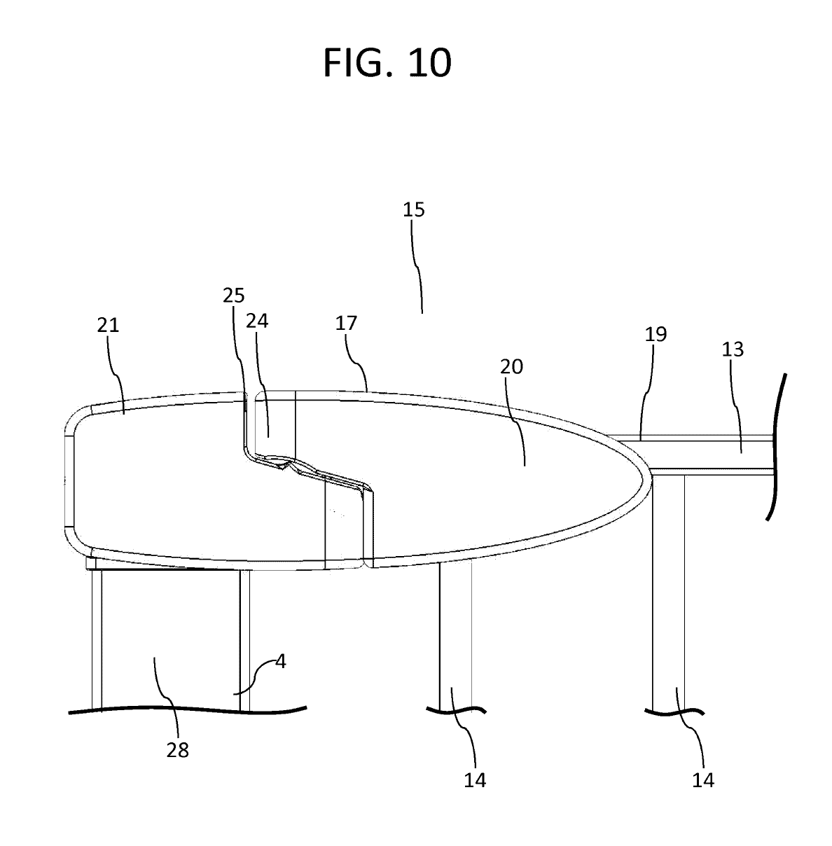

FIG. 11 is an isometric view of the hinge housing of a safety gate;

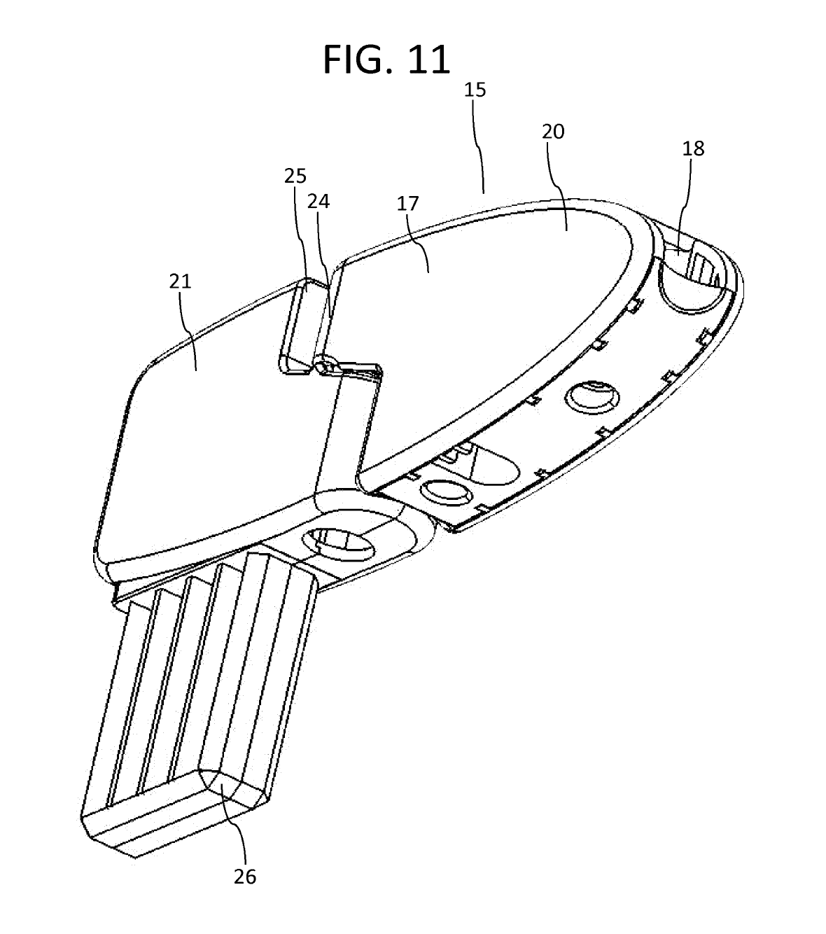

FIG. 12 is an exploded side view of the hinge housing of a safety gate;

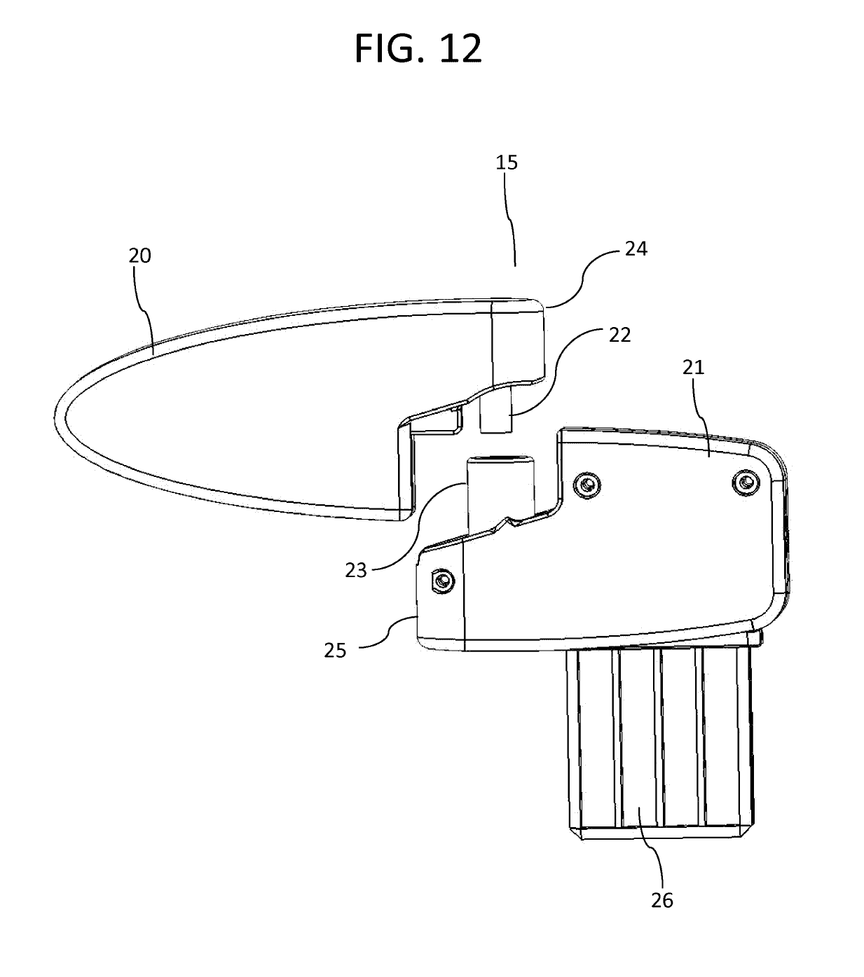

FIG. 13 is an exploded side cross-sectional view of the hinge housing of a safety gate;

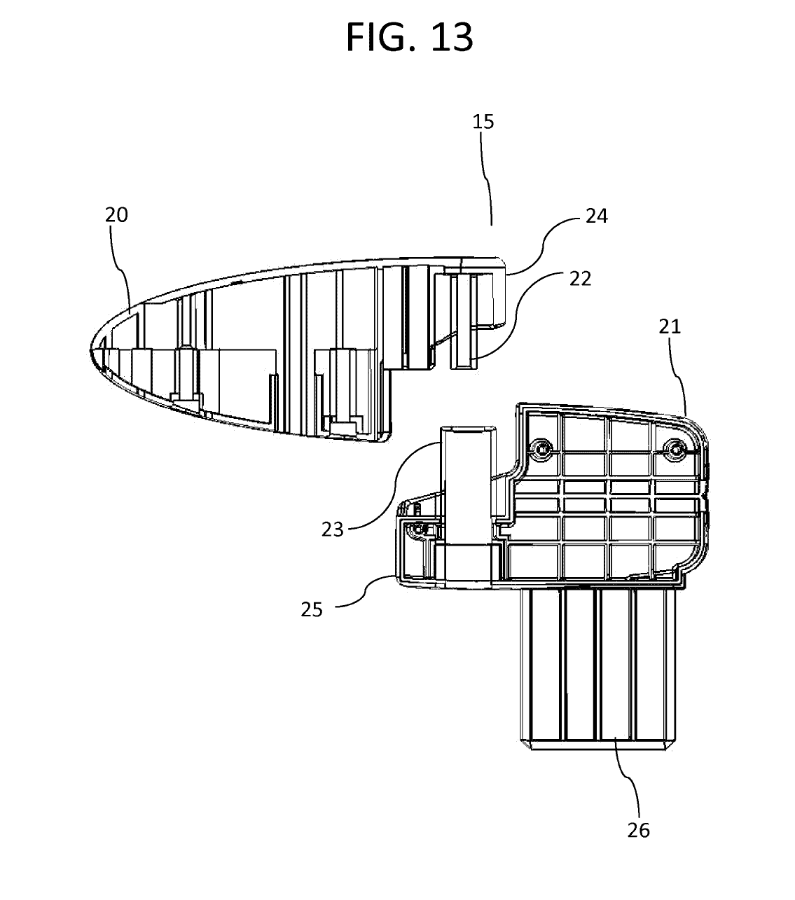

FIG. 14 is a side cross-sectional view of the hinge housing of a safety gate;

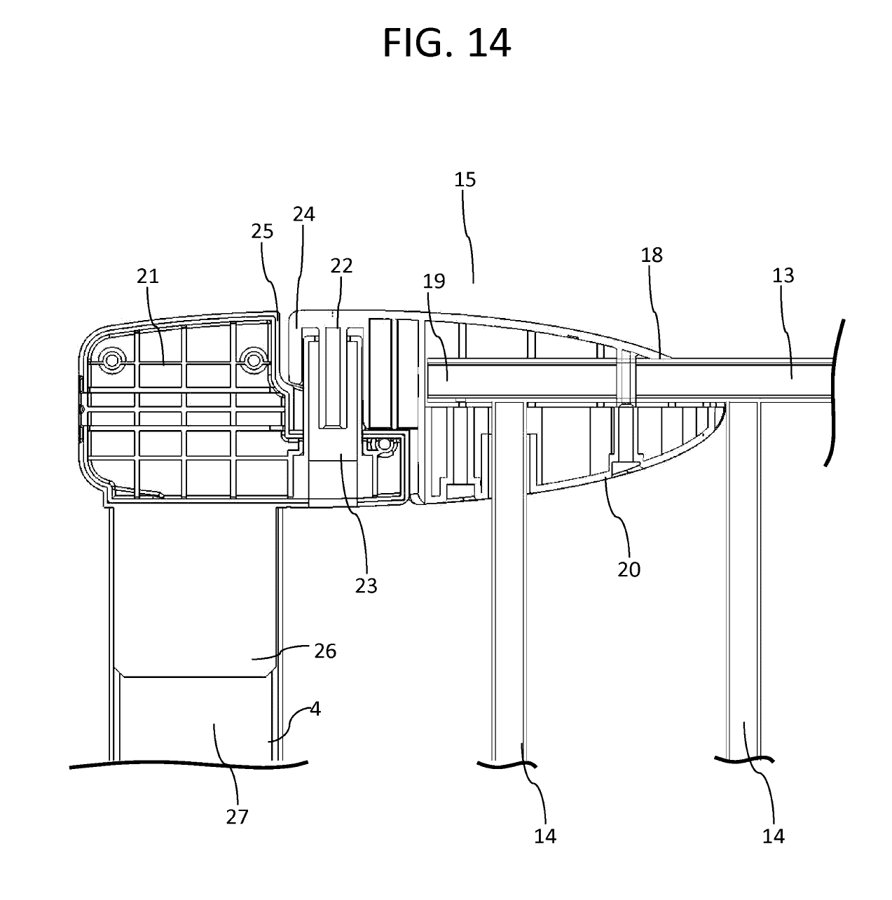

FIG. 15 is a top cross-sectional view of the hinge housing of a safety gate;

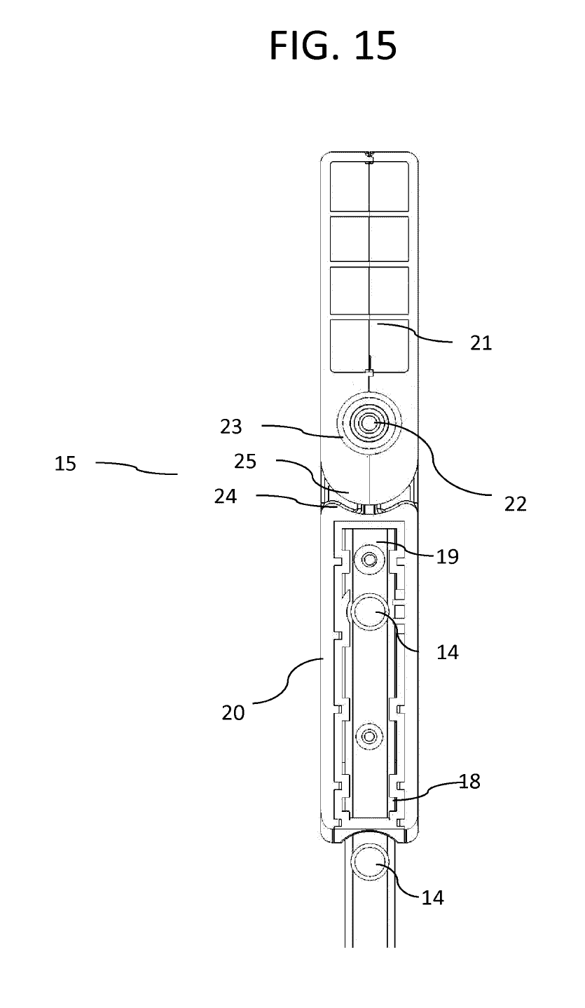

FIG. 16 is an isometric view of the fixed rear housing of the hinge housing of a safety gate;

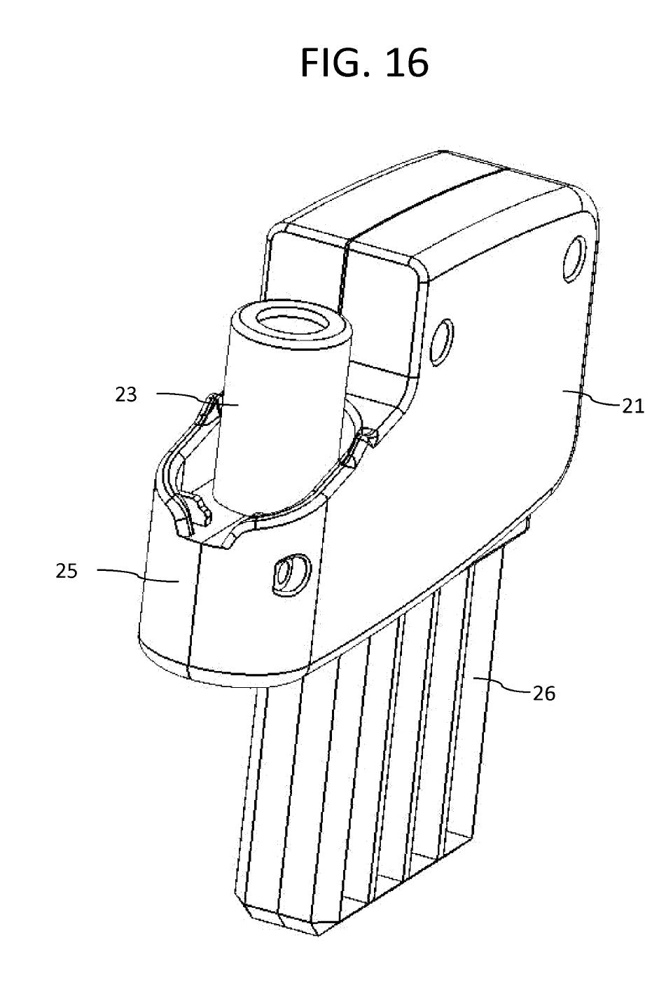

FIG. 17 is an isometric view of the rotatable front housing of the hinge housing of a safety gate;

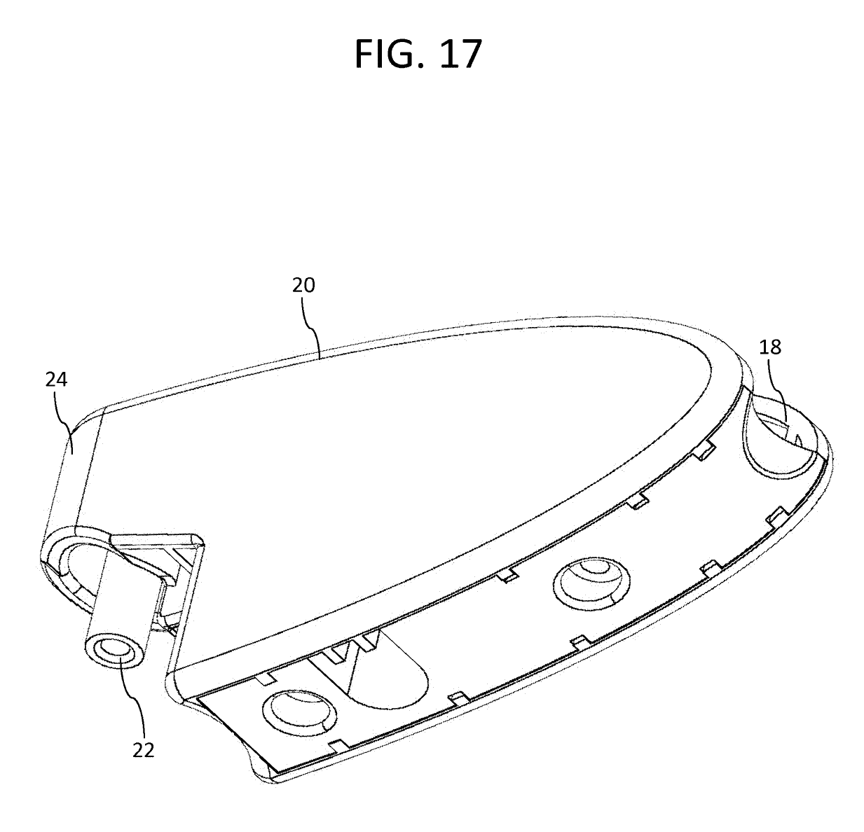

FIG. 18 is an enlarged isometric view of the latch housing of a safety gate;

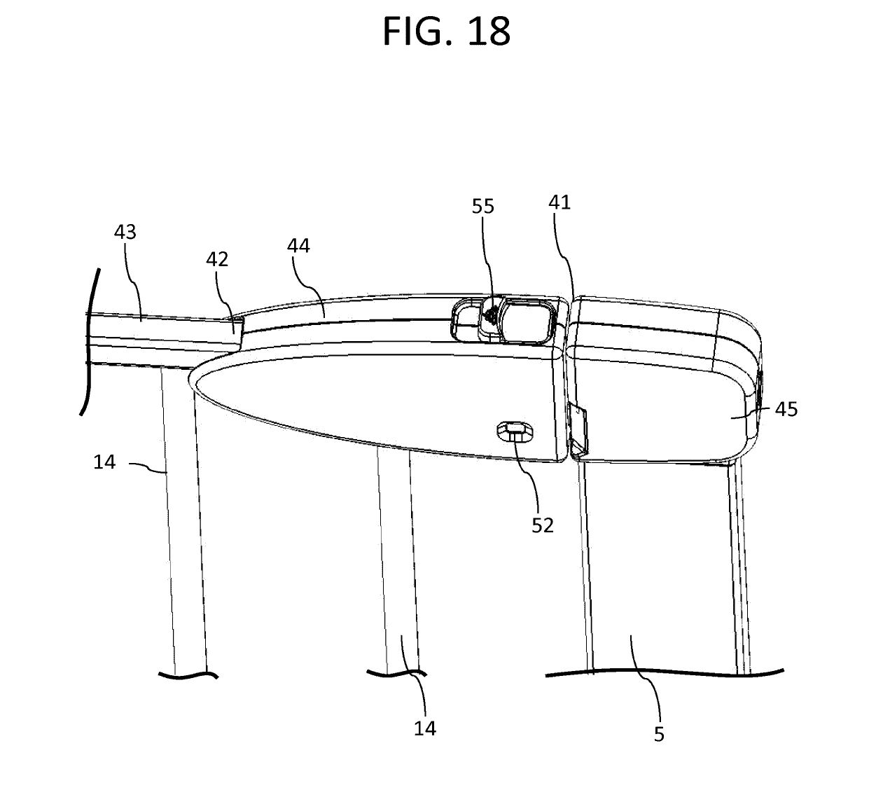

FIG. 19 is an exploded isometric view of the latch housing of a safety gate;

FIG. 20 is another exploded isometric view of the latch housing of a safety gate;

FIG. 21 is a top exploded view of the latch housing of a safety gate;

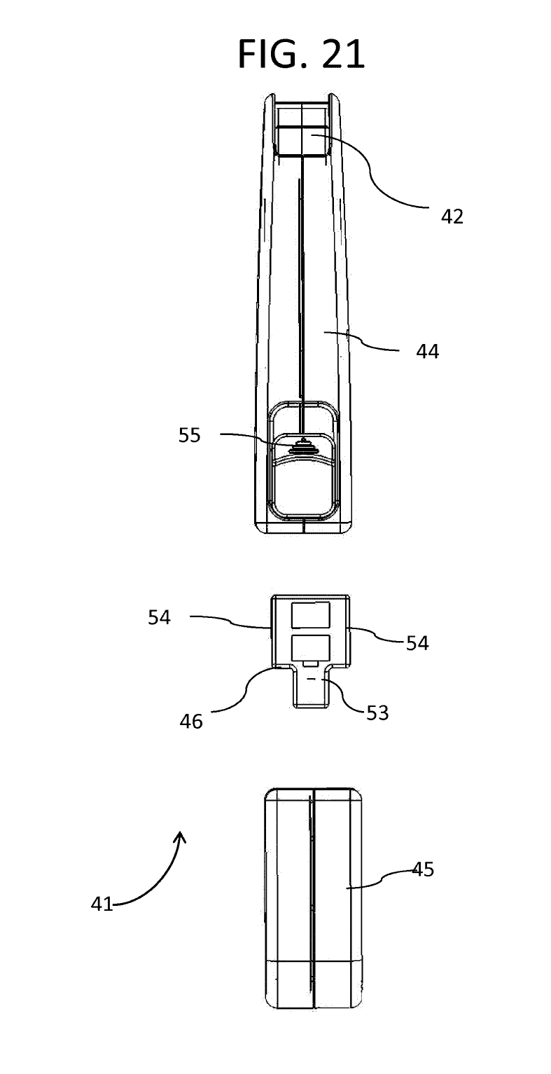

FIG. 22 is a top cross-sectional view of the latch housing of a safety gate;

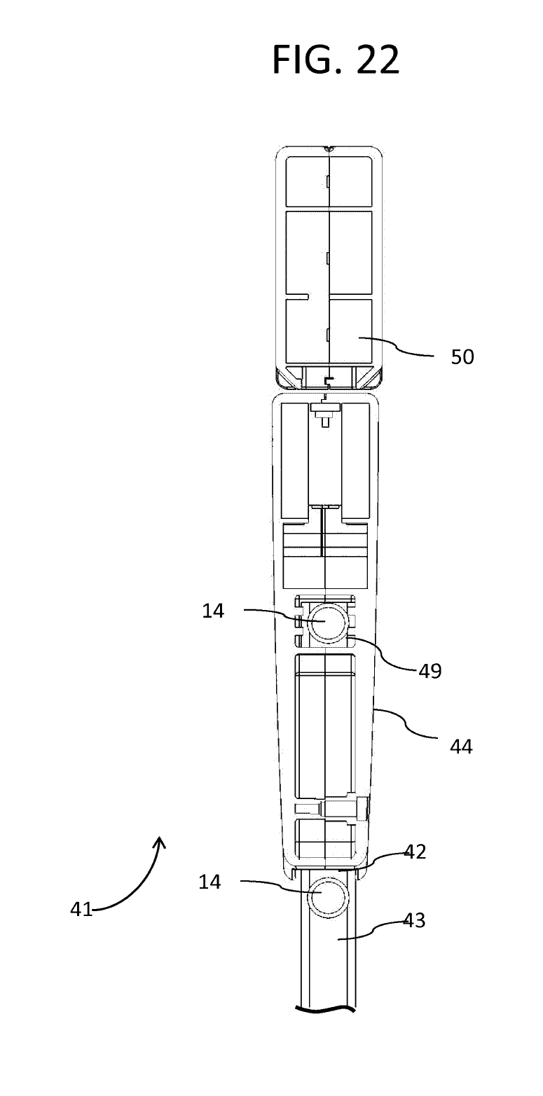

FIG. 23 is a side cross-sectional view of the latch housing of a safety gate;

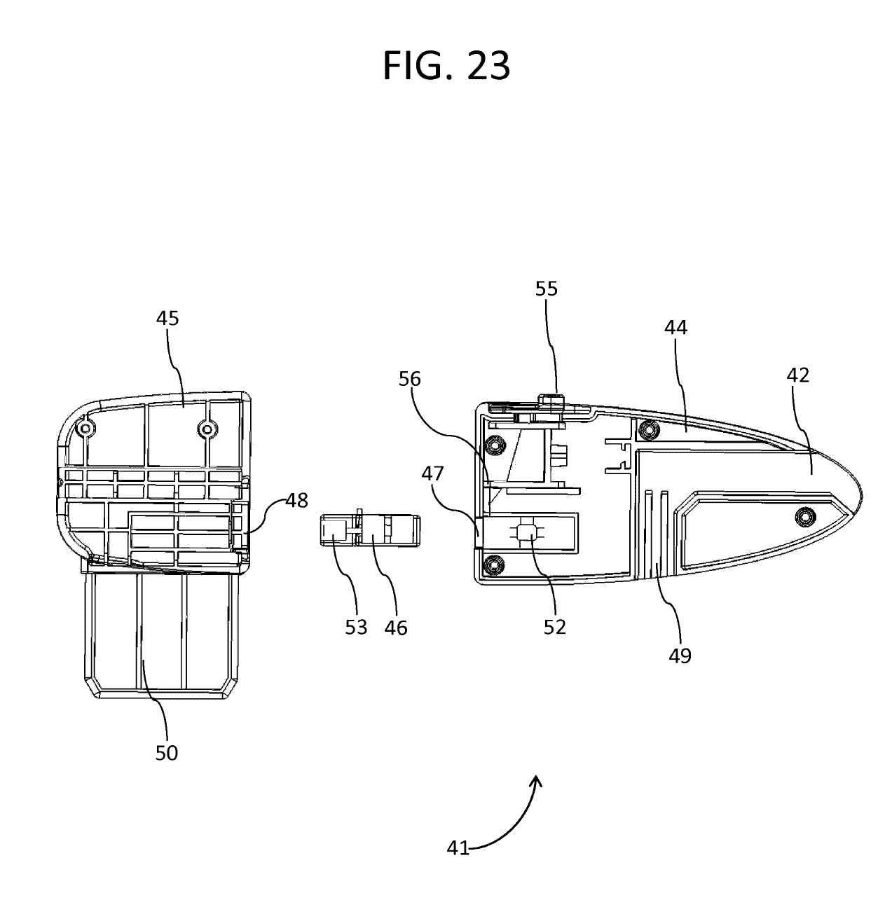

FIG. 24 is an enlarged side cross-sectional view of the latch housing of a safety gate;

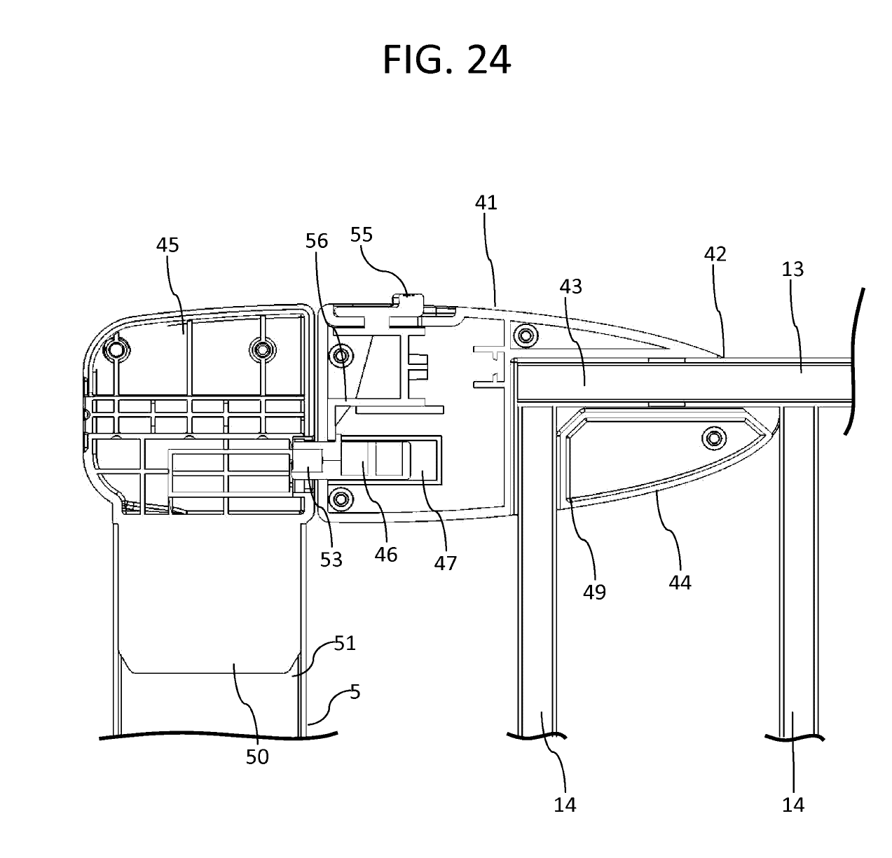

FIG. 25 is an isometric cross-sectional view of the moveable front housing of the latch housing of a safety gate;

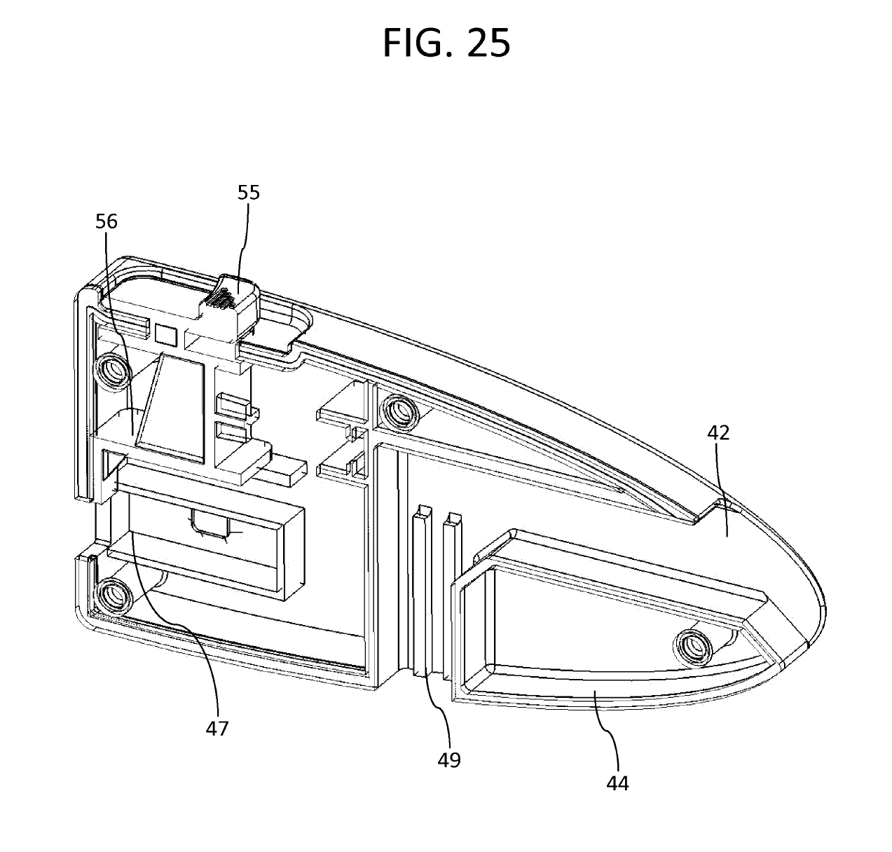

FIG. 26 is a front view of the moveable front housing of the latch housing of a safety gate;

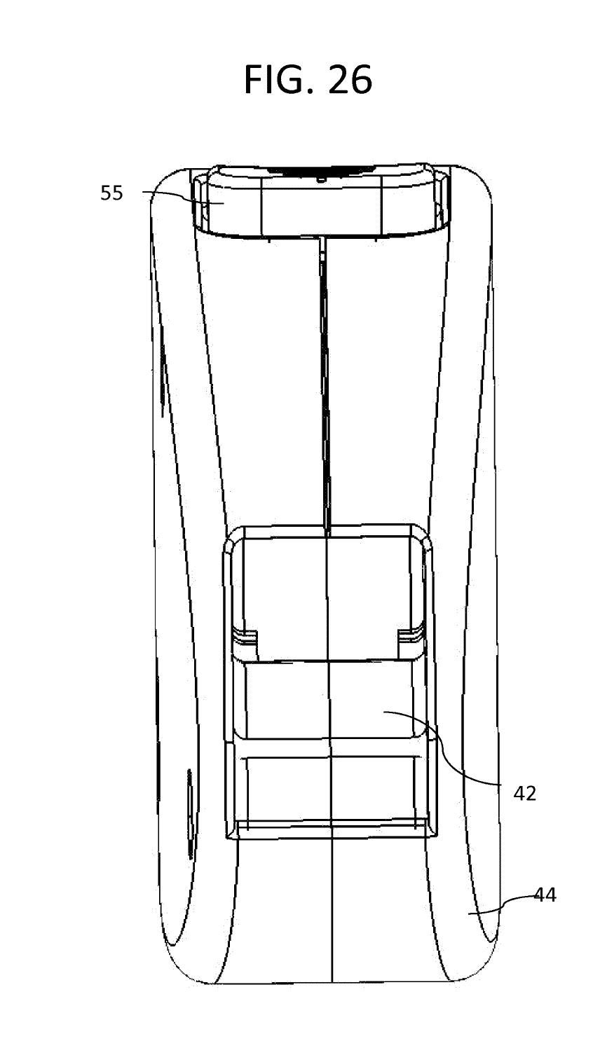

FIG. 27 is a front isometric view of the moveable front housing of the latch housing of a safety gate;

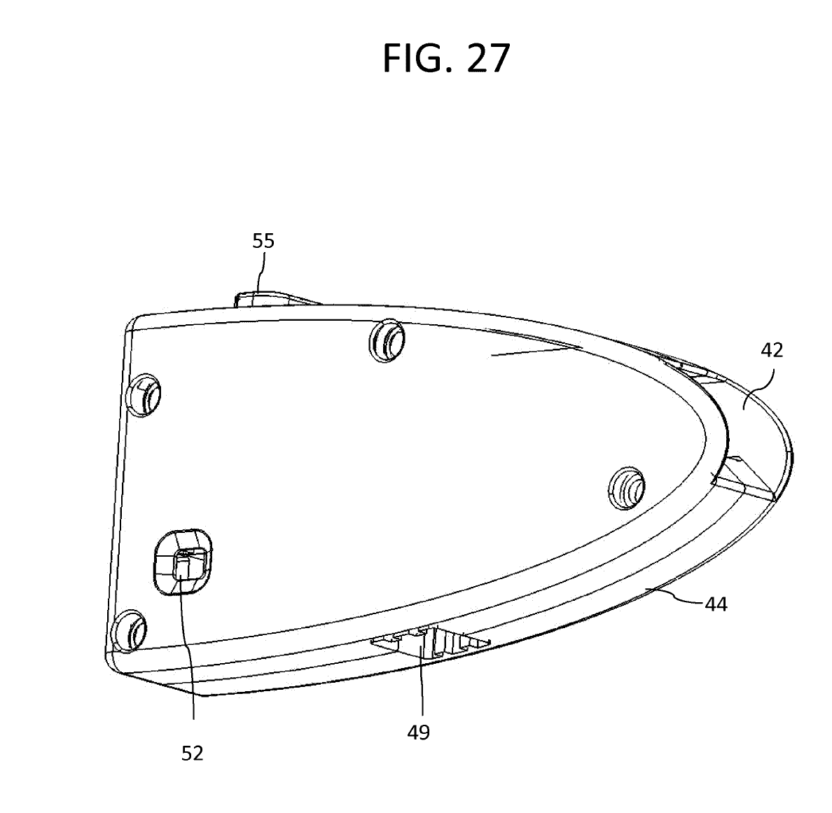

FIG. 28 is a rear isometric view of the moveable front housing of the latch housing of a safety gate;

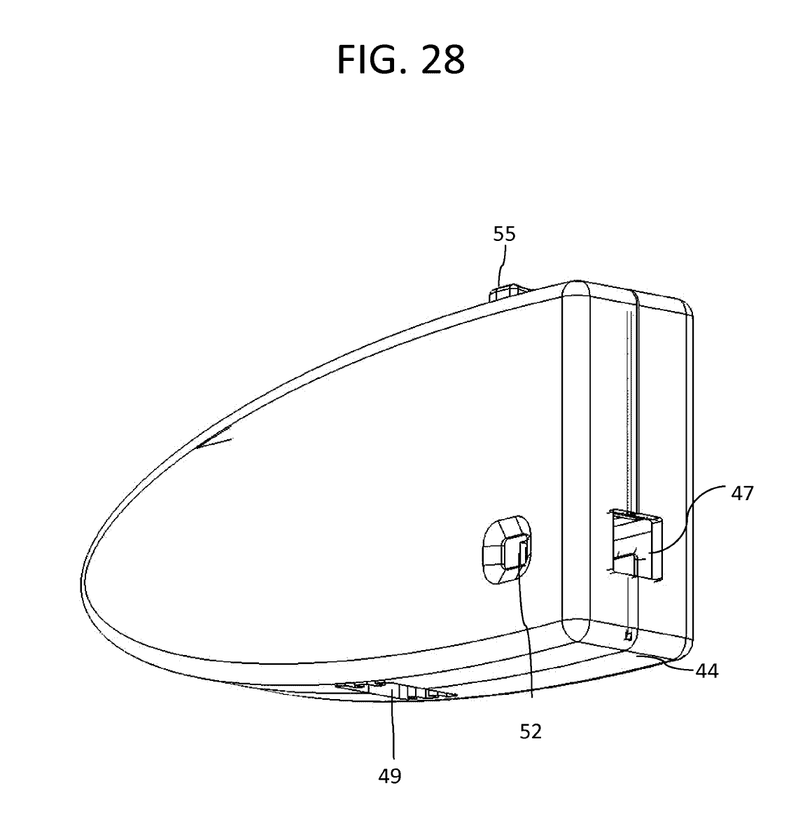

FIG. 29 is an isometric view of the internal latch of a safety gate;

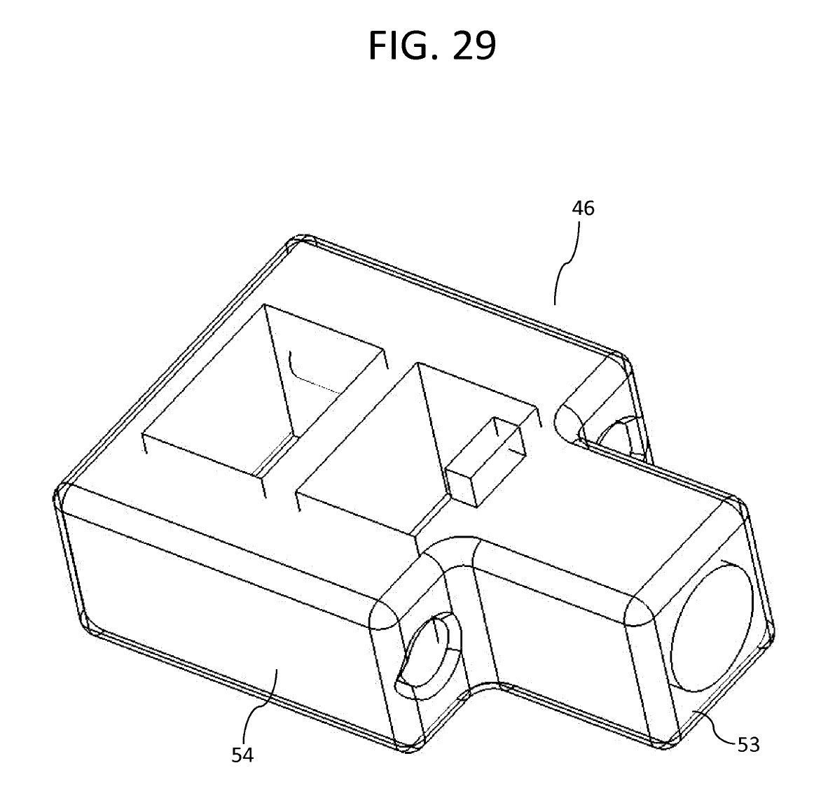

FIG. 30 is an isometric view of the fixed rear housing of the latch housing of a safety gate;

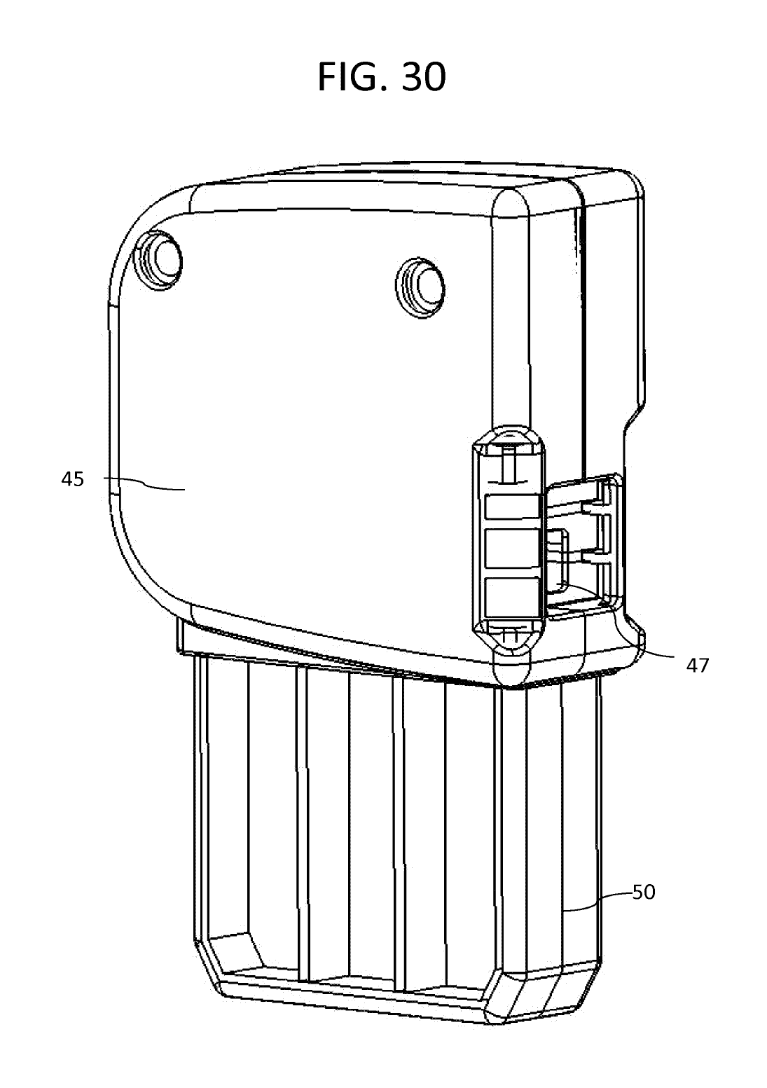

FIG. 31 is a top isometric view of the automatic stop closure mechanism of a safety gate;

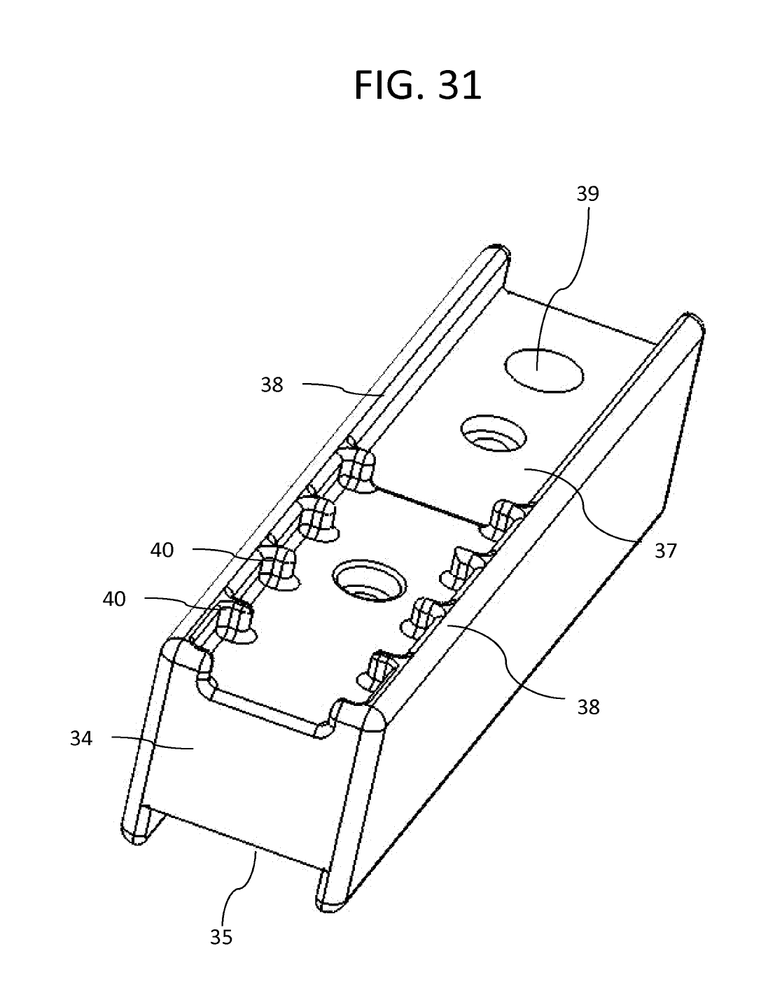

FIG. 32 is a bottom isometric view of the automatic stop closure mechanism of a safety gate;

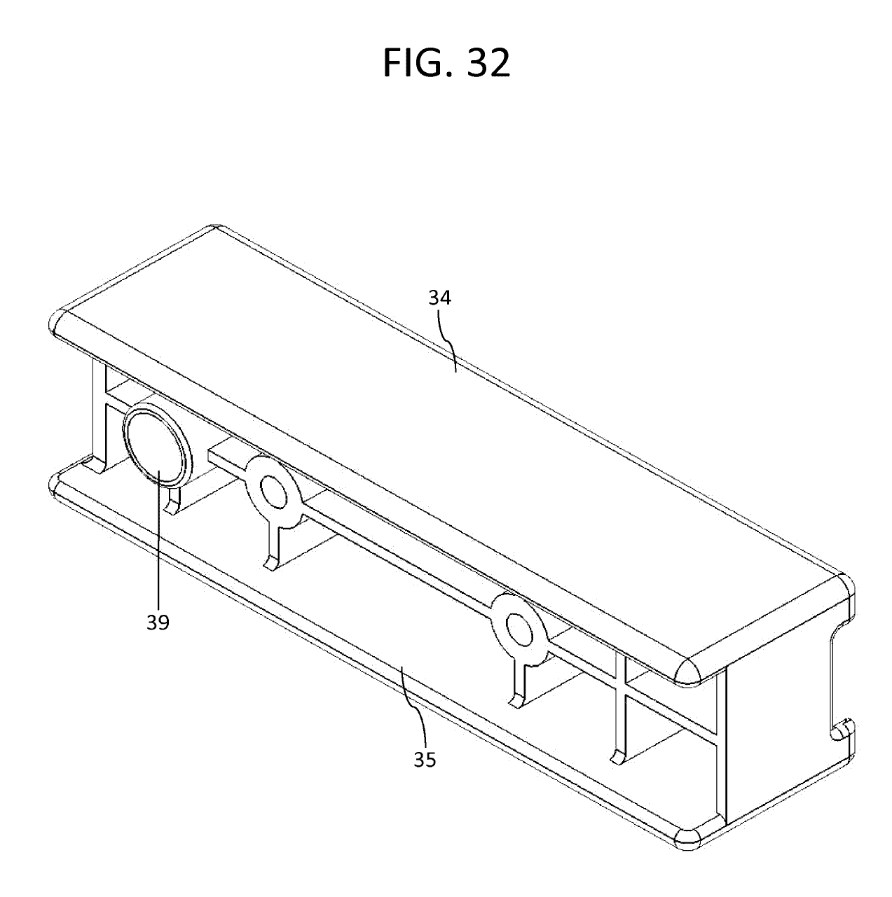

FIG. 33 is a side view of the automatic stop closure mechanism of the improved safety gate;

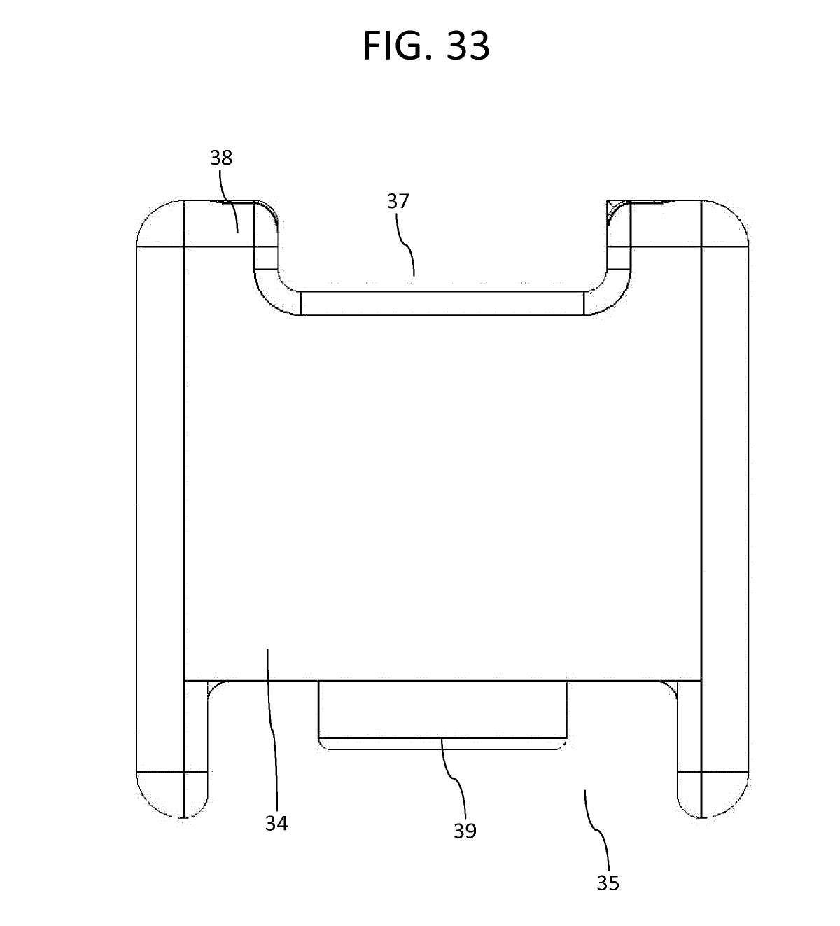

FIG. 34 is an isometric view of the bottom hinge pin housing of a safety gate;

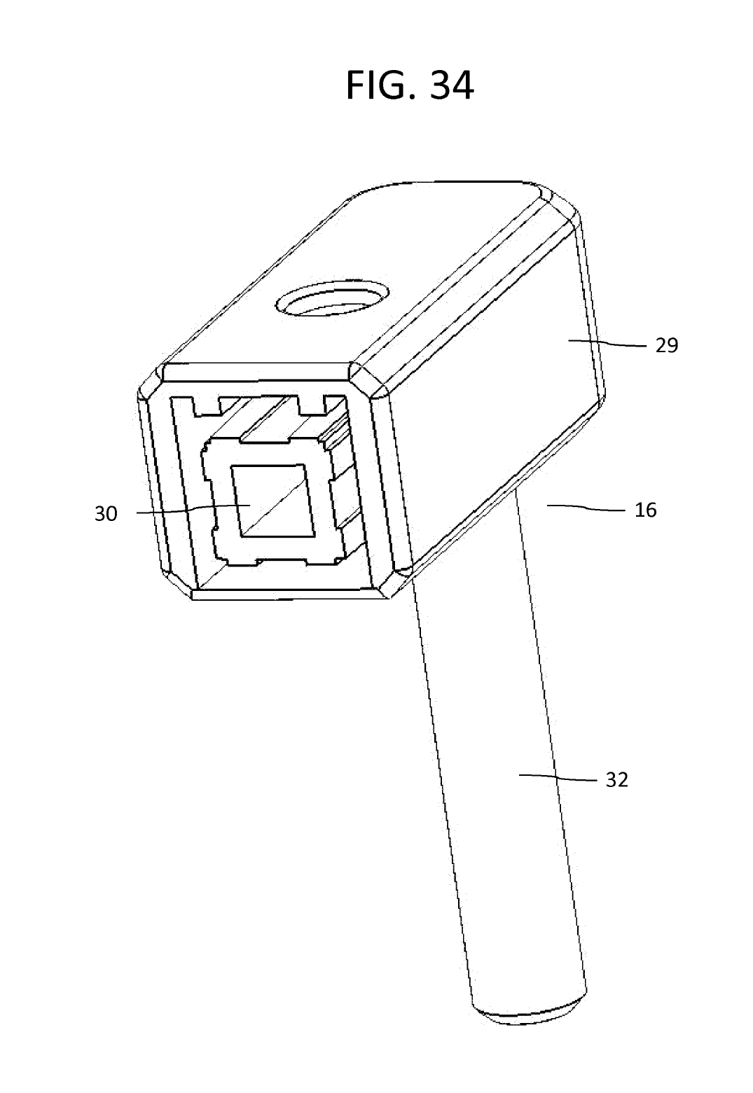

FIG. 35 is a front view of the bottom hinge pin housing of a safety gate;

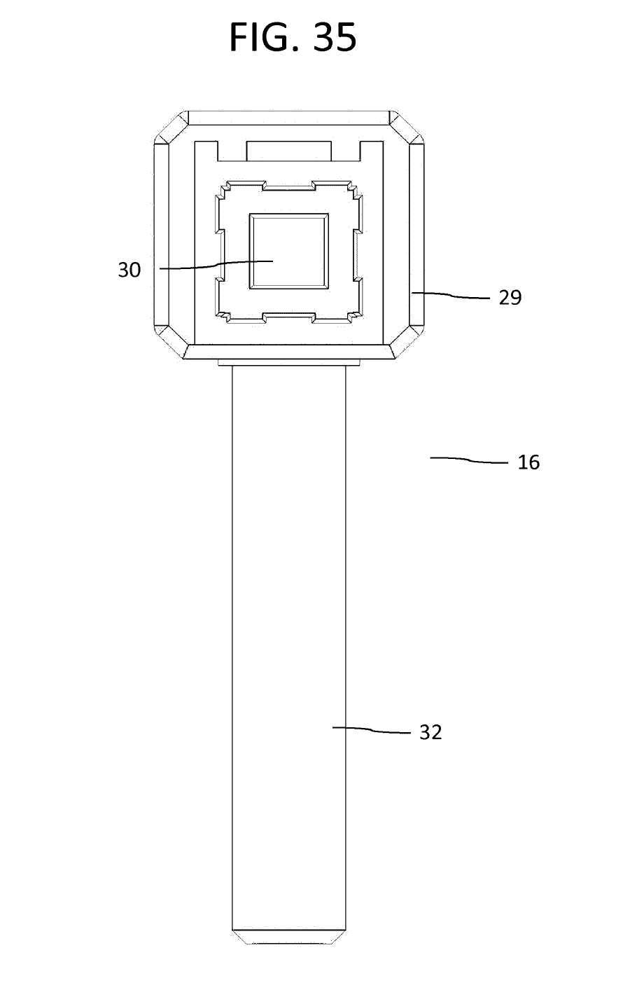

FIG. 36 is an isometric view of the bottom hinge pin housing within the automatic stop closure mechanism of a safety gate;

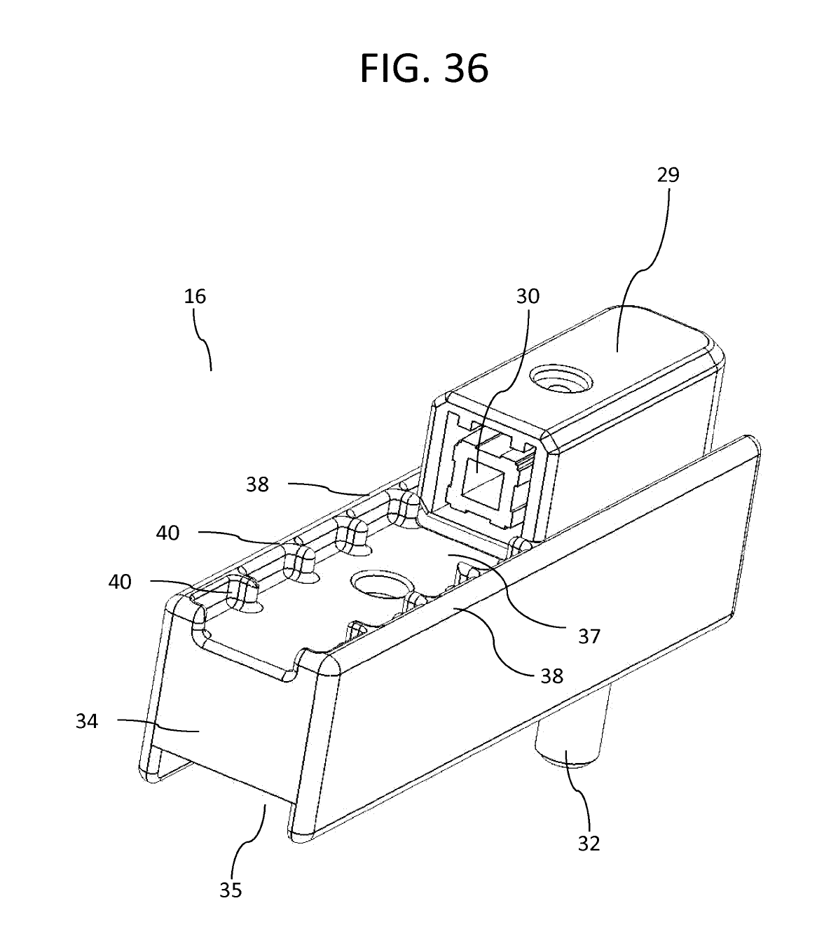

FIG. 37 is an enlarged isometric view of the bottom hinge mechanism of a safety gate;

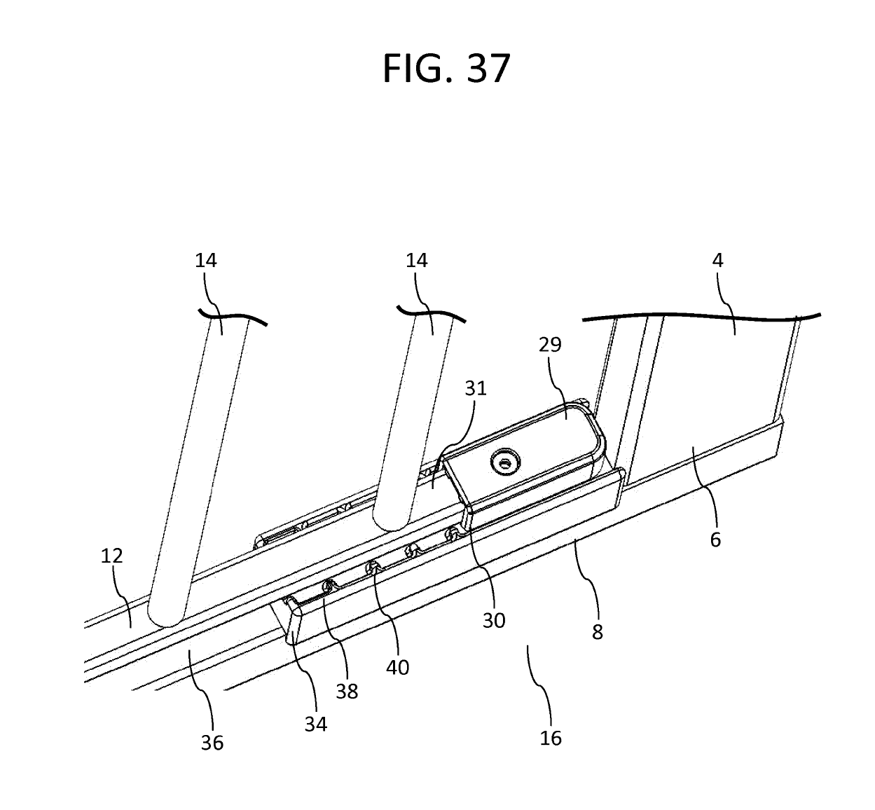

FIG. 38 is an enlarged exploded isometric view of the bottom hinge mechanism of a safety gate;

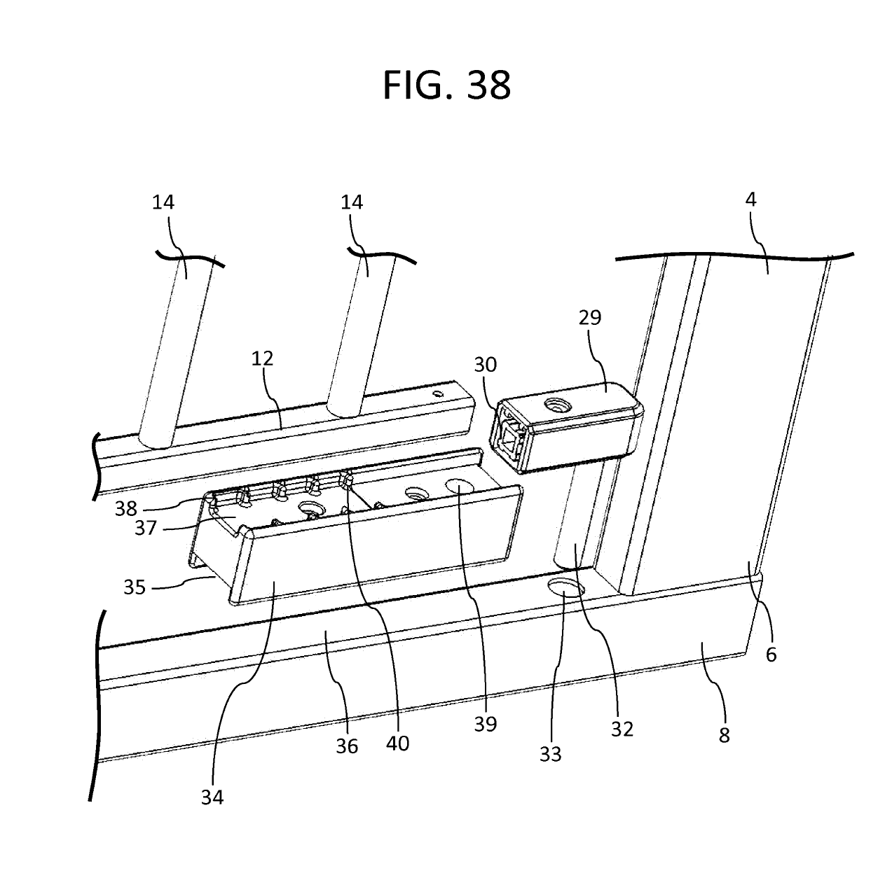

FIG. 39 is an enlarged cross-sectional side view of the bottom hinge mechanism of a safety gate;

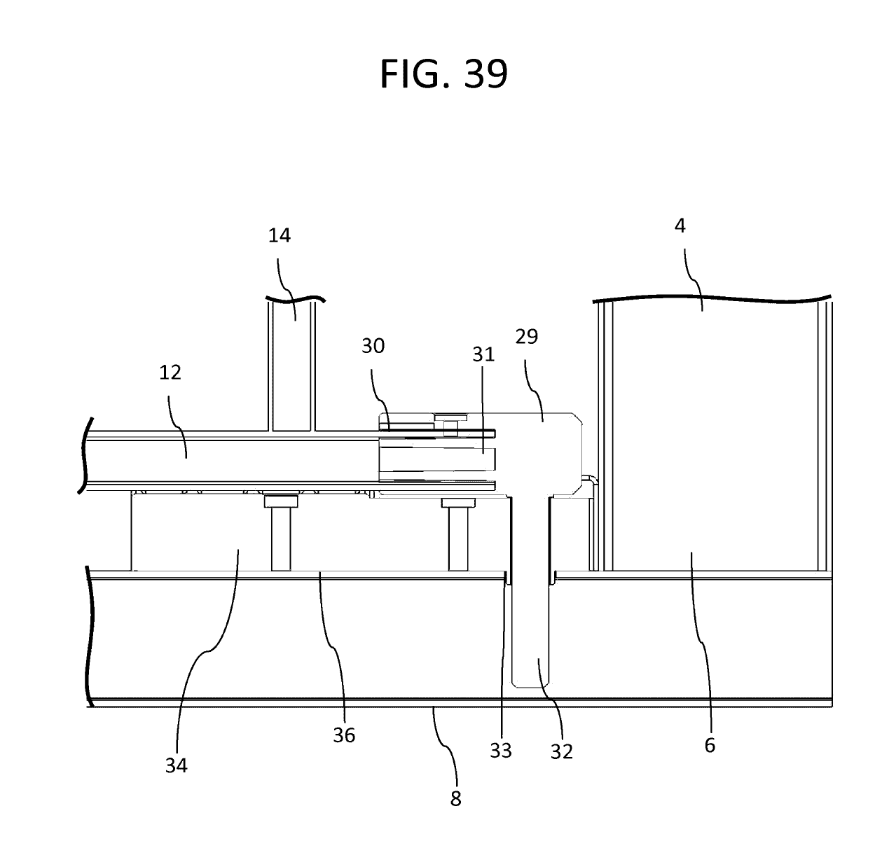

FIG. 40 is an enlarged front side view of the gate stop of a safety gate;

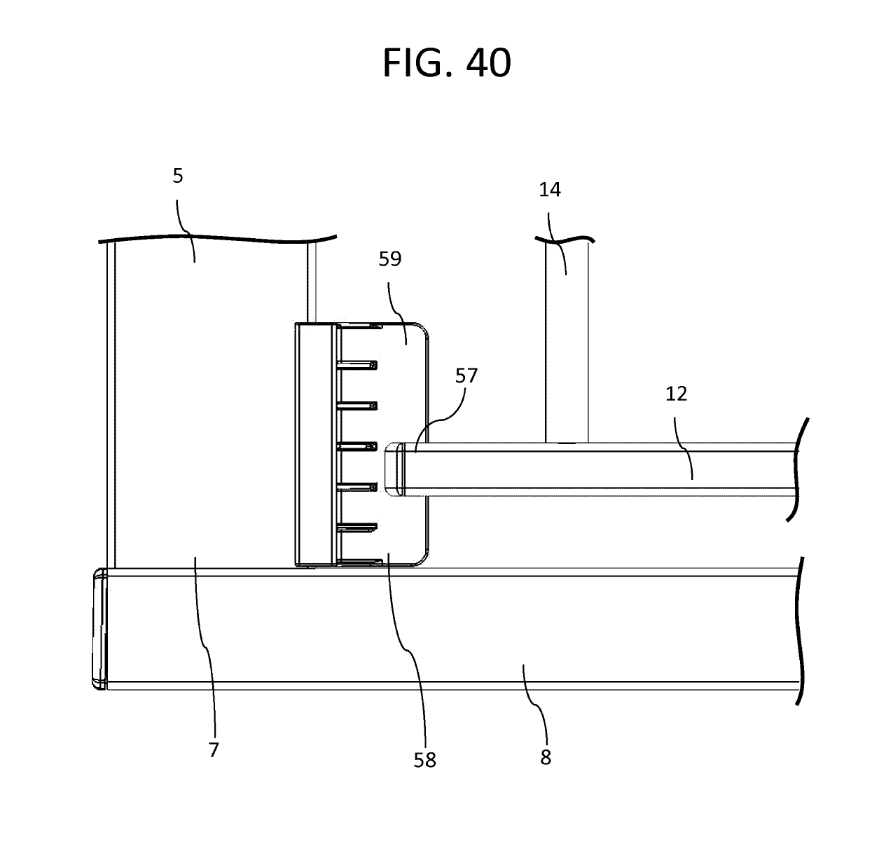

FIG. 41 is an enlarged rear side view of the gate stop of a safety gate; and

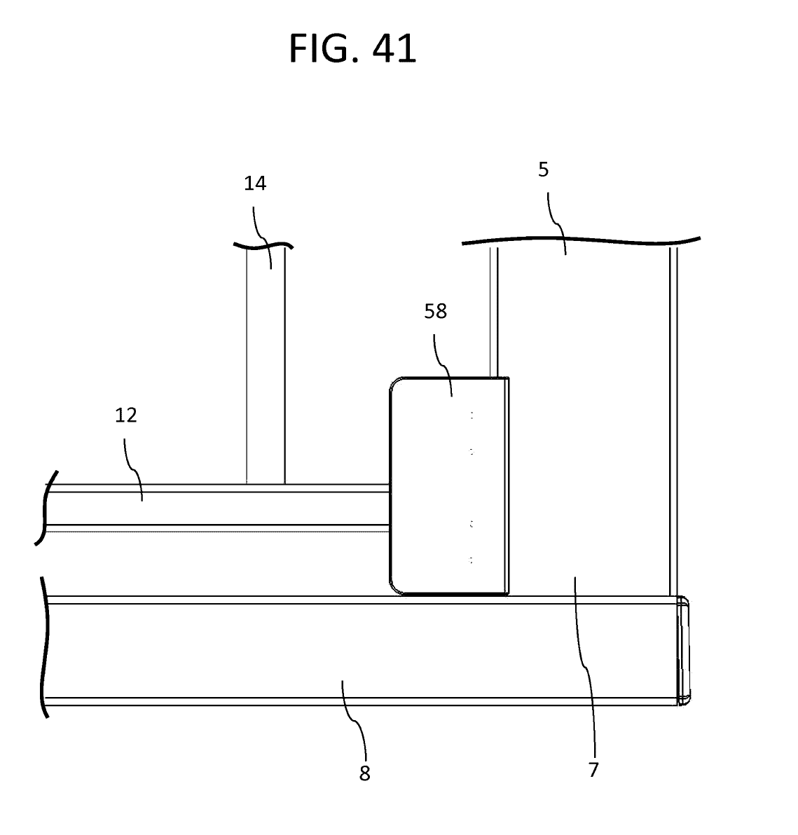

FIG. 42 is an isometric view of the gate stop of a safety gate.

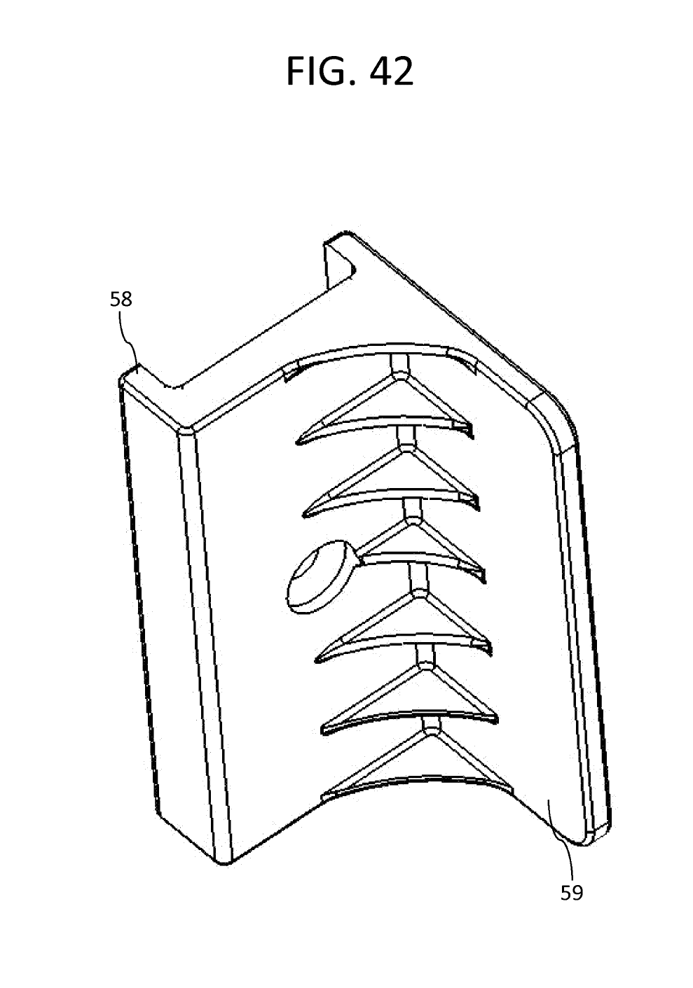

### DETAILED DESCRIPTION

Aspects of the invention are described herein with reference to certain illustrative embodiments and the figures. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

Embodiments disclosed herein relate to a safety gate for use in household openings, such as doorways, hallways, and stair landings to provide a safe barrier for a toddler or a small child.

The gate assembly 1 comprises a lightweight frame 2 with a moveable door barrier 3. The frame 2 includes two spaced apart lateral frame members 4 and 5, joined together at their respective bases 6 and 7 to a base frame member 8. The frame members 4, 5, and 8 define an opening for the door barrier 3.

The door barrier 3 is hingedly movable forward and backward relative to the frame 2. The door barrier 3 may hingedly move to one of two open positions relative to the frame 2: the door barrier 3 may move forward relative to the frame 2 to an angle substantially 90 to 120 degrees, or the door barrier 3 may move backward relative to the frame 2 to an angle substantially 90 to 120 degrees. In either open position, passage through the door barrier 3 is possible.

The closed position of the door 3 is substantially parallel relative to the frame 2. In the closed position, passage through the door barrier 3 is prevented.

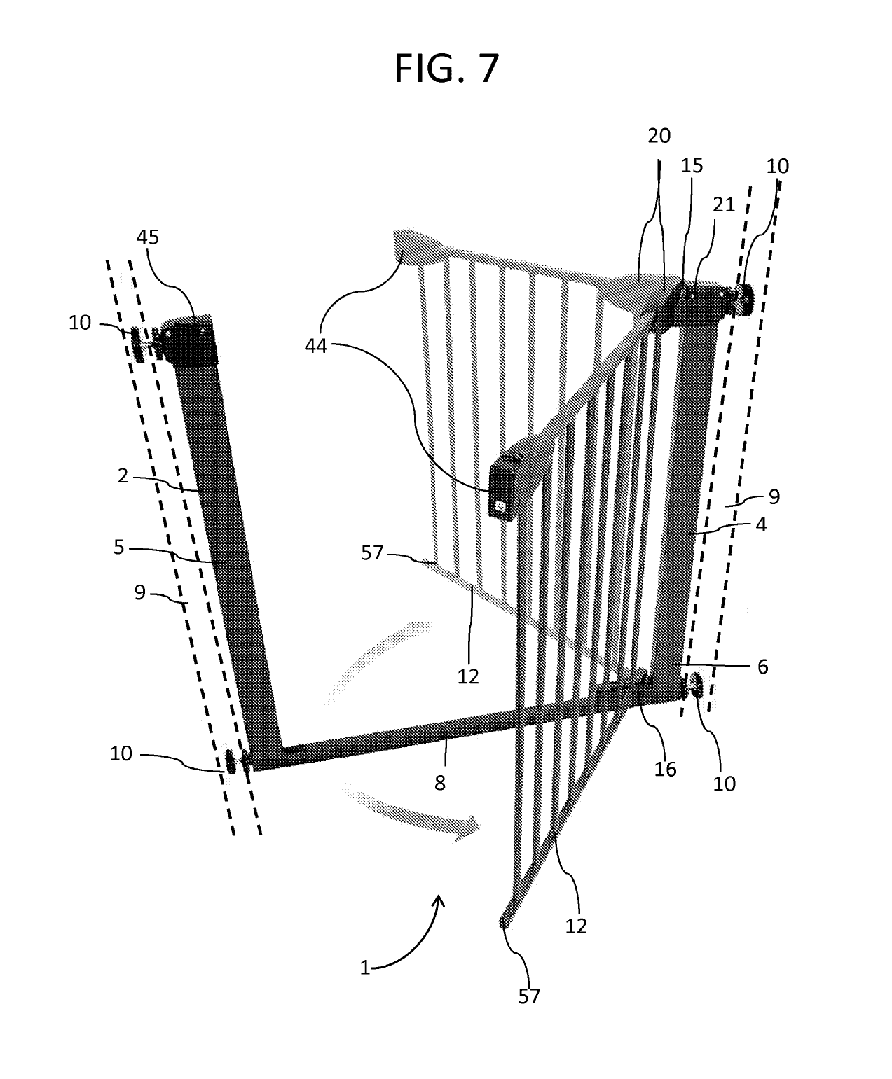

As may be seen in FIG. 7, The frame 2 may be positioned within a doorway 9 or wall opening with removable pressure mounts 10. The pressure mounts can be quickly released to move the gate assembly 1 to another desired location in the household.

The door barrier 3 comprises a panel 11 having a base member 12, a top member 13, and a plurality of struts 14 at spaced intervals between frame members 4 and 5. The door barrier 3 is hingedly joined to frame member 5 via a top hinge 15 and a bottom hinge 16.

The top hinge 15 comprises a top hinge panel 17 with a channel 18 that receives and holds one end 19 of top member 13 of panel 11. The top hinge panel 17 comprises a rotatable front housing 20 and a fixed rear housing 21. The rotatable front housing 20 and the fixed rear housing 21 are connected with a top hinge pin 22 inserted into a lower hinge pin 23. The rear face 24 of the rotatable front housing 20 has a substantially complementary shape to the front face 25 of fixed rear housing 21. The top hinge pin 22, lower hinge pin 23, and the complementary shape of the rear face 24 to the front face 25 permit the top hinge panel 17 and the door barrier 3 to fully rotate in either direction, backward and forward, with respect to the frame 2 along the axis of the top hinge pin 22 and the lower hinge pin 23.

The fixed rear housing 21 of the top hinge panel 17 further comprises a base member 26 for insertion into channel 27 on top end 28 of frame member 4. Base member 27 and holds the rear housing 21 in a fixed position as the front housing 20 rotates relative to the frame 2.

The bottom hinge 16 of the door barrier 3 comprises a bottom hinge housing 29 with a channel 30 that receives and holds one end 31 of base member 12 of panel 11. The bottom hinge housing 29 comprises a bottom hinge pin 32 that inserts into channel 33 in base frame member 8. The bottom hinge pin 32 and the complementary shape of channel 33 permit the bottom hinge housing 29 and the door barrier 3 to fully rotate in either direction, backward and forward, with respect to the frame 2 along the axis of bottom hinge pin 32. This bottom rotational axis is substantially the same rotational axis of the top hinge pin 22 and the lower hinge pin 23 of the top hinge panel 17.

The bottom hinge housing 29 and one end 31 of base member 12 of panel 11 also extend into an automatic gate closure stop 34. Automatic gate closure stop 34 may include a compressible resilient material that comprises a bottom recess 35 which rests on the top surface 36 of base frame member 8. Bottom recess 35 may be substantially elongate with a longitudinal axis that is substantially parallel to base frame member 8. Automatic gate closure stop 34 also may include a narrow top recess 37 for removably holding bottom hinge housing 29 when the door barrier 3 is in the closed position. Top recess 37 may be substantially elongate with a longitudinal axis that is substantially parallel to base frame member 8. Top recess 37 may have two sidewalls 38 composed of compressible resilient material and a channel 39 for receiving and holding bottom hinge pin 32 that inserts into channel 33 in base frame member 8. Top recess 37 also may comprise a series of lateral protrusions 40 composed of compressible resilient material extending from sidewalls 38.

The non-hinged, swinging side of the door barrier 3 may include a top latch panel 41 with a channel 42 that receives and holds one end 43 of top member 13 of panel 11.

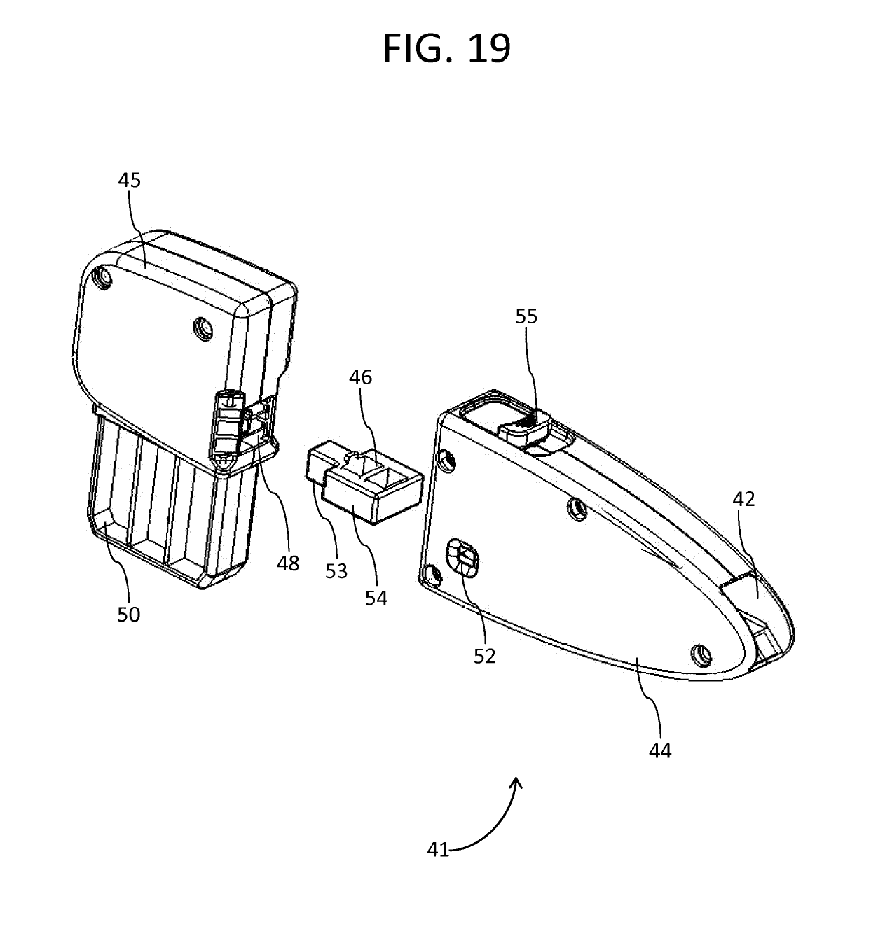

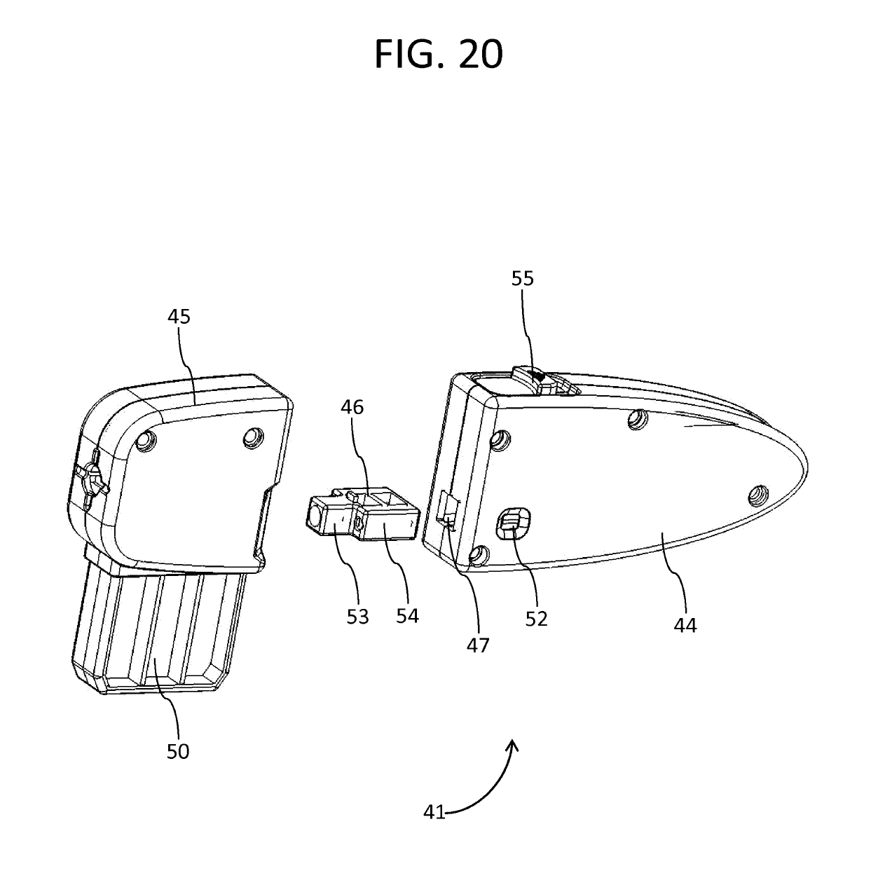

The top latch panel 41 may include a moveable front housing 44 and a fixed rear housing 45. The moveable front housing 44 and a fixed rear housing 45 are connected with an internal latch 46 that inserted into a rear channel 47 (see, for example, FIG. 20) on moveable front housing 44 and a front channel 48 (see, for example, FIG. 19) on fixed rear housing 45. The moveable front housing 44 comprises a channel 49 that receives and holds one of the door barrier struts 14.

The fixed rear housing 45 of the top latch panel 41 may further comprise a base member 50 for insertion into channel 51 of frame member 5. Base member 50 and holds the rear housing 45 in a fixed position as the moveable front housing 44 is unlatched from frame 2.

The moveable front housing 44 comprises visual openings 52 on one or both sides of the housing. Visual openings 52 substantially align with the internal latch 46. In the closed, latched position of the door barrier 3, a first end 53 of the internal latch 46 is contained within channel 48 of fixed rear housing 45. In this latched position, the portions of sidewalls 54 that are farther away from fixed rear housing 45 are visible through openings 52. In FIG. 19, this portion is on the right side of sidewall 54. The portion that is visible when the door barrier 3 is latched may have a first color, such as green, or any other suitable color. These portions of the sidewalls 54 of the internal latch 46 are visible, from a distance, through visual openings 52 on one or both sides of the moveable front housing 44. Thus, with the door barrier 3 in the latched position, with internal latch 46 within channel 48 of the fixed rear housing 45, a green color is visible on one or both sides of moveable front housing 44 through visual openings 52. This green color indicates that the gate 1 is locked, as the first end 53 of the internal latch 46 is within channel 48 of the fixed rear housing 45. This indication can be viewed from a distance.

The moveable front housing 44 further comprises a top button 55 that contains an internal lever 56 which engages the internal latch 46 to move it out of channel 48 and fixed rear housing 45. To open the door barrier 3, a user grips moveable front housing 44 and slides button 55 away from fixed rear housing 45 using his or her fingers. Once the internal latch 46 is engaged by internal level 56 and removed from rear housing 45, the moveable front housing 44 is disengaged from the rear fixed housing 45, and the door barrier 3 may begin rotation in either direction relative to frame 2.

Once the internal latch 46 is in an unlatched position, the user lifts moveable front housing 44 using the same hand, thereby lifting automatic gate closure stop 34 out of the top recess 37 away from the sidewalls 38 and lateral protrusions 40. With automatic gate closure stop 34 clear of top recess 37, door barrier 3 may be moved to an open position. This movement permits the bottom hinge housing 29, and the door barrier 3, to fully rotate in either direction, backward and forward, with respect to the frame 2 along the axis of bottom hinge pin 32.

As door barrier 3 is opened, the bottom hinge pin 32 rotates within channel 33 of base frame member 8 and channel 39 of top recess 37 of the automatic gate closure stop 34. This bottom rotational axis is substantially the same rotational axis of the top hinge pin 22 and the lower hinge pin 23 of the top hinge panel 17.

In this unlocked position, different portion of the sidewalls 54 of the internal latch 46 are visible through openings 52. For example, the portions that are closer to the rear fixed housing 45 are visible through openings 52. In the embodiment shown in FIG. 19, the left side of sidewall 54 would be visible through opening 52 when the internal latch is in the unlocked position. These portions of the sidewalls 52 have a second color that is different from the first color. For example, the second color may be red or any other suitable color. These portions of the sidewalls 54 of the internal latch 46 are visible through visual openings 52 on either side of the moveable front housing 44. Thus, with the door barrier 3 in the unlatched position, and with internal latch 46 no longer within channel 48 of the fixed rear housing 45, a red color (or other suitable color) is visible on either side of moveable front housing 44 through visual openings 52. This red color indicates, from a distance, that the gate 1 is unlocked, as the internal latch 46 is not contained within channel 48 of the fixed rear housing 45.

From the door barrier 3 open position of the gate assembly 1, the automatic gate closure stop 34 compresses against the compressible resilient material of the sidewalls 38 and the lateral protrusions 40. This resilient force automatically pulls the automatic gate closure stop 34 and the attached the door barrier 3, bottom hinge housing 29, attached end 31 of base member 12 back toward top recess 37. This pulling rotates bottom hinge pin 32 within channel 33 of base frame member 8 and channel 39 of top recess 41. Once the door barrier 3 is proximate to the closing position, the automatic gate closure stop 34 is substantially aligned and drops down between sidewalls 38 and protrusions 40. This dropping down of automatic gate closure stop 34 substantially aligns door barrier 3 with respect to frame 2 and moves the gate assembly 1 into a locked position.

With the door barrier 3 in the locked position, the first color (e.g., green) of the internal latch 46 is visible on either side of moveable front housing 44 through visual openings 52. This green color indicates, from a distance, that the gate 1 is locked, as the first end 53 of the internal latch 46 is within channel 48 of the fixed rear housing 45.

The bottom second end 57 of base member 12 of panel 11 is free to rotate with door barrier 3. The gate assembly 1 comprises a gate stop 58 attached to frame 4. The gate stop 58 comprises an a flat extension 59 for engaging a second end 57 of the base member 12 and preventing further rotation of panel 11 and door barrier 3. In some embodiments of the present disclosure, the gate stop 58 is rotatable to stop the door barrier 3 in either direction for placement of the gate in either forward or backward orientation in any doorway 9.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A safety gate comprising:
a gate frame;
a barrier attached to the frame and pivotable relative to the frame between open and closed positions;
a latch housing with an opening;
a latch configured to engage the frame and the barrier simultaneously to retain the barrier in the closed position;
the latch being movable to release the barrier from the frame such that the barrier can be moved to an open position, wherein the latch is attached to a first surface having a first color and a second surface having a second color which is different from the first color;
wherein when the latch is engaged with the frame and the barrier such that the barrier is retained in the closed position, the first surface having the first color is visible through the opening, and when the latch is disengaged such that the barrier is not retained in the closed position, the second surface having the second color is visible through the opening.

2. A safety gate as in claim 1, wherein the latch is slidable within the latch housing.

3. A safety gate as in claim 2, wherein the latch is slidable within a channel of the latch housing.

4. A safety gate as in claim 1, wherein the latch is mounted within a portion of the latch housing that is attached to the pivotable barrier.

5. A safety gate as in claim 4, wherein the frame comprises a fixed portion of the latch housing, and the fixed portion has a channel into which the latch is movable.

6. A safety gate as in claim 1, wherein when the second color is visible through the opening, the first color is not visible.

7. A safety gate as in claim 6, wherein when the first color is visible through the opening, the second color is not visible.

8. A safety gate as in claim 1, wherein the first color is green and the second color is red.

9. A safety gates as in claim 1, wherein a user-actuated actuator moves the latch.

10. A safety gate as in claim 1, wherein the frame is reversibly positionable in the doorway to reverse the orientation of the open position of the barrier.

11. A safety gate as in claim 1, further comprising a closure mechanism which biases the barrier from the open position toward the closed position.

12. A safety gate as in claim 1, wherein the barrier includes a movable portion of the latch housing, and a top surface and a bottom surface of the latch housing are curved from a side view.
